(19) United States
(12) Patent Application Publication
(10) Pub. No.: US 2026/0281576 A1
(43) Pub. Date: Sep. 17, 2026

(54) SENSOR DEVICE AND METHOD FOR OPERATING A SENSOR DEVICE

(71) Applicant: Sony Semiconductor Solutions Corporation, Kanagawa (JP)

(72) Inventors: Christian Peter BRÄNDLI, Stuttgart (DE); Koji OGAWA, Stuttgart (DE)

(73) Assignee: Sony Semiconductor Solutions Corporation, Kanagawa (JP)

(21) Appl. No.: 19/163,887

(22) PCT Filed: Mar. 7, 2024
(86) PCT No.: PCT/EP2024/055935

§ 371 Date: Sep. 10, 2025

(30) Foreign Application Priority Data
Mar. 27, 2023 (EP) 23164342.0

(51) Int. Cl. H04N 25/677; G06V 10/82; H04N 25/47

(52) U.S. Cl. CPC H04N 25/677; G06V 10/82; H04N 25/47

(57) ABSTRACT

A sensor device comprises a pixel array comprising a plurality of pixels each being configured to receive light and to perform photoelectric conversion to generate an electrical signal, a storage unit that is configured to store fixed pattern noise, FPN, data indicating FPN of the pixel array, and an output unit that is configured to output the electrical signals generated by the pixels and the FPN data.

### FIELD OF THE INVENTION

The present technology relates to a sensor device and a method for operating a sensor device, in particular, to a sensor device and a method for operating a sensor device that allows an improved treatment of fixed pattern noise.

### BACKGROUND

In imaging systems like active pixel sensors, APS, and dynamic/event vision sensors, DVS/EVS, single pixels come with a slight mismatch in performance due to unavoidable imprecision of the manufacturing process, causing variations in the pixel size, the material or the connection to the sensor circuitry as well as due to offset or gain errors, e.g. in postamplification stages. Thus, small differences in the individual responsivity of the pixels of such image sensors exist. These differences lead to a variation in pixel-brightness (or output intensity of each pixel) occurring in images taken under the same illumination conditions in an imaging array. This variation is called fixed pattern noise, FPN, and is a specific property of each image sensor/image sensor chip, meaning that each pixel array formed on a chip/die/substrate has its own FPN. Of course, FPN deteriorates the output of the imaging devices.

Improved sensor devices and methods for operating these sensor devices are desirable that mitigate the problems caused by FPN.

### SUMMARY OF INVENTION

To this end, a sensor device is provided that comprises a pixel array comprising a plurality of pixels each being configured to receive light and to perform photoelectric conversion to generate an electrical signal, a storage unit that is configured to store fixed pattern noise, FPN, data indicating FPN of the pixel array, and an output unit that is configured to output the electrical signals generated by the pixels and the FPN data.

Further, a method for operating an according sensor device is provided, which comprises: receiving light and performing photoelectric conversion to generate an electrical signal with pixels of the pixel array; and outputting, with the output unit, the electrical signals generated by the pixels and the FPN data stored in the storage unit.

By storing information about the FPN on the sensor device and by providing this data together with the sensor data measured by the pixel array, it is possible to use these data together to mitigate the effects of FPN.

### BRIEF DESCRIPTION OF DRAWINGS

FIG. 1 is a schematic diagram of a sensor device.

FIG. 2 is a schematic block diagram of a sensor section.

FIG. 3 is a schematic block diagram of a pixel array section.

FIG. 4 is a schematic circuit diagram of a pixel block.

FIG. 5 is a schematic block diagram illustrating of an event detecting section.

FIG. 6 is a schematic circuit diagram of a current-voltage converting section.

FIG. 7 is a schematic circuit diagram of a subtraction section and a quantization section.

FIG. 8 is a schematic diagram of a frame data generation method based on event data.

FIG. 9 is a schematic block diagram of another quantization section.

FIG. 10 is a schematic diagram of another event detecting section.

FIG. 11 is a schematic block diagram of another pixel array section.

FIG. 12 is a schematic circuit diagram of another pixel block.

FIG. 13 is a schematic block diagram of a scan-type sensor device.

FIG. 14 is a schematic block diagram of a sensor device.

FIG. 15 is a schematic illustration of a process flow of a method for operating a sensor device.

FIG. 16 is a schematic block diagram of another sensor device.

FIG. 17 is a schematic illustration showing generation of FPN data.

FIG. 18 is a schematic illustration of a sensor system.

FIG. 19 is a schematic illustration of a process flow of a method for operating a sensor device.

FIG. 20 is a schematic illustration of a process flow of optimizing artificial intelligence algorithms used in a sensor system.

FIG. 21 is a schematic block diagram of a vehicle control system.

FIG. 22 is a diagram of assistance in explaining an example of installation positions of an outside-vehicle information detecting section and an imaging section.

FIGS. 23A and 23B are schematic illustrations of a mobile device and a head mounted display comprising a sensor device.

### DETAILED DESCRIPTION

The present disclosure is directed to mitigating problems caused by fixed pattern noise, FPN, of imaging sensors. The solutions to these problems discussed below are applicable to all according sensor types. They are particularly relevant for event based/dynamic vision sensors, EVS/DVS, since it has shown that manufacturing an EVS/DVS with small FPN is much more difficult than in the case of a conventional image sensor. In order to simplify the description and also in order to cover an important application example, the present description is focused therefore without prejudice on EVS/DVS. However, it has to be understood that although in the following reference will be made to the circuitry of EVS/DVS, the discussed solutions can be applied in principle to all pixel-based sensor devices. The discussed sensor devices may be implemented in any imaging sensor setup such as e.g. smartphone cameras, scientific devices, automotive video sensors or the like.

First, a possible implementation of a EVS/DVS will be described. This is of course purely exemplary. It is to be understood that EVSs/DVSs could also be implemented differently.

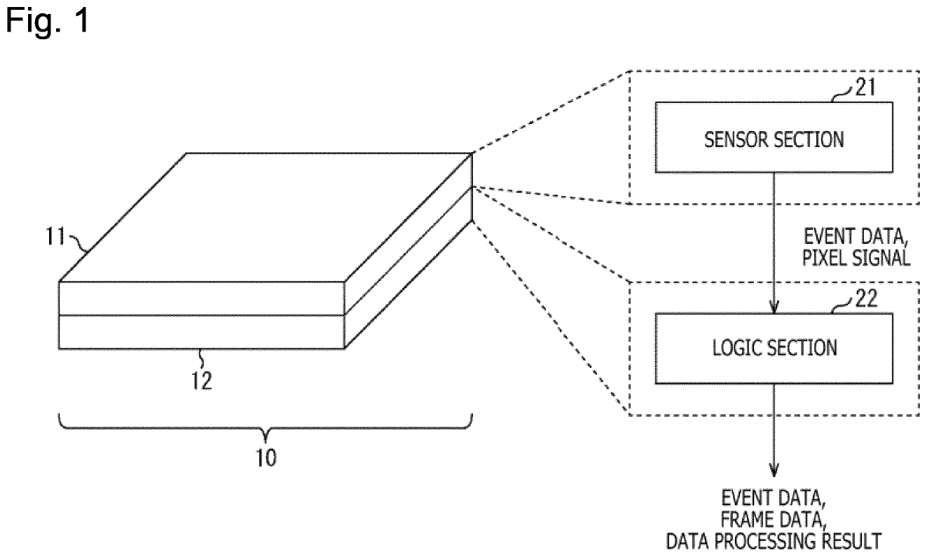

FIG. 1 is a diagram illustrating a configuration example of a sensor device 10, which is in the example of FIG. 1 constituted by a sensor chip.

The sensor device 10 is a single-chip semiconductor chip and includes a sensor die (substrate) 11, which serves as a plurality of dies (substrates), and a logic die 12 that are stacked. Note that, the sensor device 10 can also include only a single die or three or more stacked dies.

In the sensor device 10 of FIG. 1, the sensor die 11 includes (a circuit serving as) a sensor section 21, and the logic die 12 includes a logic section 22. Note that, the sensor section 21 can be partly formed on the logic die 12. Further, the logic section 22 can be partly formed on the sensor die 11.

The sensor section 21 includes pixels configured to perform photoelectric conversion on incident light to generate electrical signals, and generates event data indicating the occurrence of events that are changes in the electrical signal of the pixels. The sensor section 21 supplies the event data to the logic section 22. That is, the sensor section 21 performs imaging of performing, in the pixels, photoelectric conversion on incident light to generate electrical signals, similarly to a synchronous image sensor, for example. The sensor section 21, however, generates event data indicating the occurrence of events that are changes in the electrical signal of the pixels instead of generating image data in a frame format (frame data). The sensor section 21 outputs, to the logic section 22, the event data obtained by the imaging.

Here, the synchronous image sensor is an image sensor configured to perform imaging in synchronization with a vertical synchronization signal and output frame data that is image data in a frame format. The sensor section 21 can be regarded as asynchronous (an asynchronous image sensor) in contrast to the synchronous image sensor, since the sensor section 21 does not operate in synchronization with a vertical synchronization signal when outputting event data. In particular, the sensor section 21 can output event data with a temporal precision of 10⁻⁶ s.

Note that, the sensor section 21 may generate and output, other than event data, frame data, similarly to the synchronous image sensor. In addition, the sensor section 21 can output, together with event data, electrical signals of pixels in which events have occurred, as pixel signals that are pixel values of the pixels in frame data.

The logic section 22 controls the sensor section 21 as needed. Further, the logic section 22 performs various types of data processing, such as data processing of generating frame data on the basis of event data from the sensor section 21 and image processing on frame data from the sensor section 21 or frame data generated on the basis of the event data from the sensor section 21, and outputs data processing results obtained by performing the various types of data processing on the event data and the frame data. The logic section 22 may implement the functions of a control unit as described below.

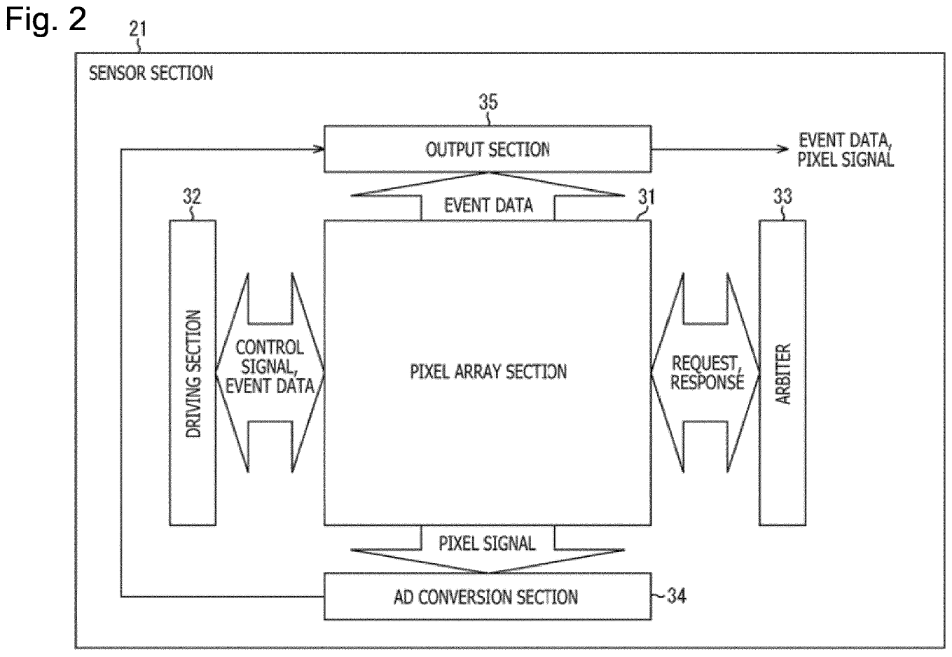

FIG. 2 is a block diagram illustrating a configuration example of the sensor section 21 of FIG. 1.

The sensor section 21 includes a pixel array section 31, a driving section 32, an arbiter 33, an AD (Analog to Digital) conversion section 34, and an output section 35.

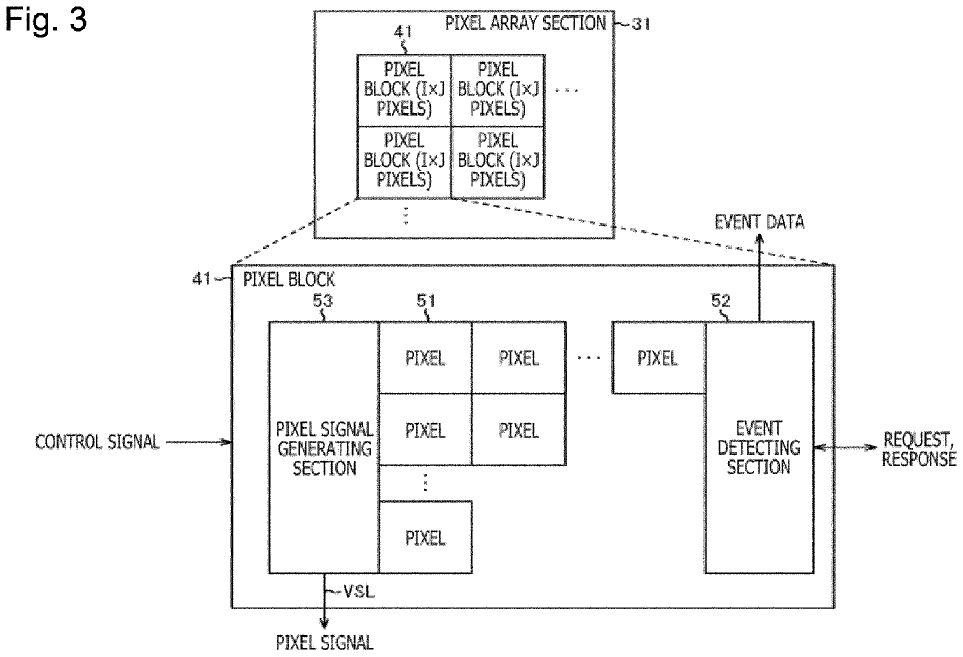

The pixel array section 31 includes a plurality of pixels 51 (FIG. 3) arrayed in a two-dimensional lattice pattern. The pixel array section 31 detects, in a case where a change larger than a predetermined threshold (including a change equal to or larger than the threshold as needed) has occurred in (a voltage corresponding to) a photocurrent that is an electrical signal generated by photoelectric conversion in the pixel 51, the change in the photocurrent as an event. In a case of detecting an event, the pixel array section 31 outputs, to the arbiter 33, a request for requesting the output of event data indicating the occurrence of the event. Then, in a case of receiving a response indicating event data output permission from the arbiter 33, the pixel array section 31 outputs the event data to the driving section 32 and the output section 35. In addition, the pixel array section 31 may output an electrical signal of the pixel 51 in which the event has been detected to the AD conversion section 34.

The driving section 32 supplies control signals to the pixel array section 31 to drive the pixel array section 31. For example, the driving section 32 drives the pixel 51 regarding which the pixel array section 31 has output event data, so that the pixel 51 in question supplies (outputs) a pixel signal to the AD conversion section 34.

The arbiter 33 arbitrates the requests for requesting the output of event data from the pixel array section 31, and returns responses indicating event data output permission or prohibition to the pixel array section 31.

The AD conversion section 34 includes, for example, a single-slope ADC (AD converter) (not illustrated) in each column of pixel blocks 41 (FIG. 3) described later, for example. The AD conversion section 34 performs, with the ADC in each column, AD conversion on pixel signals of the pixels 51 of the pixel blocks 41 in the column, and supplies the resultant to the output section 35. Note that, the AD conversion section 34 can perform CDS (Correlated Double Sampling) together with pixel signal AD conversion.

The output section 35 performs necessary processing on the pixel signals from the AD conversion section 34 and the event data from the pixel array section 31 and supplies the resultant to the logic section 22 (FIG. 1).

Here, a change in the photocurrent generated in the pixel 51 can be recognized as a change in the amount of light entering the pixel 51, so that it can also be said that an event is a change in light amount (a change in light amount larger than the threshold) in the pixel 51.

Event data indicating the occurrence of an event at least includes location information (coordinates or the like) indicating the location of a pixel block in which a change in light amount, which is the event, has occurred. Besides, the event data can also include the polarity (positive or negative) of the change in light amount.

With regard to the series of event data that is output from the pixel array section 31 at timings at which events have occurred, it can be said that, as long as the event data interval is the same as the event occurrence interval, the event data implicitly includes time point information indicating (relative) time points at which the events have occurred. However, for example, when the event data is stored in a memory and the event data interval is no longer the same as the event occurrence interval, the time point information implicitly included in the event data is lost. Thus, the output section 35 includes, in event data, time point information indicating (relative) time points at which events have occurred, such as timestamps, before the event data interval is changed from the event occurrence interval. The processing of including time point information in event data can be performed in any block other than the output section 35 as long as the processing is performed before time point information implicitly included in event data is lost.

FIG. 3 is a block diagram illustrating a configuration example of the pixel array section 31 of FIG. 2.

The pixel array section 31 includes the plurality of pixel blocks 41. The pixel block 41 includes the I×J pixels 51 that are one or more pixels arrayed in I rows and J columns (I and J are integers), an event detecting section 52, and a pixel signal generating section 53. The one or more pixels 51 in the pixel block 41 share the event detecting section 52 and the pixel signal generating section 53. Further, in each column of the pixel blocks 41, a VSL (Vertical Signal Line) for connecting the pixel blocks 41 to the ADC of the AD conversion section 34 is wired.

The pixel 51 receives light incident from an object and performs photoelectric conversion to generate a photocurrent serving as an electrical signal. The pixel 51 supplies the photocurrent to the event detecting section 52 under the control of the driving section 32.

The event detecting section 52 detects, as an event, a change larger than the predetermined threshold in photocurrent from each of the pixels 51, under the control of the driving section 32. In a case of detecting an event, the event detecting section 52 supplies, to the arbiter 33 (FIG. 2), a request for requesting the output of event data indicating the occurrence of the event. Then, when receiving a response indicating event data output permission to the request from the arbiter 33, the event detecting section 52 outputs the event data to the driving section 32 and the output section 35.

The pixel signal generating section 53 generates, in the case where the event detecting section 52 has detected an event, a voltage corresponding to a photocurrent from the pixel 51 as a pixel signal, and supplies the voltage to the AD conversion section 34 through the VSL, under the control of the driving section 32.

Here, detecting a change larger than the predetermined threshold in photocurrent as an event can also be recognized as detecting, as an event, absence of change larger than the predetermined threshold in photocurrent. The pixel signal generating section 53 can generate a pixel signal in the case where absence of change larger than the predetermined threshold in photocurrent has been detected as an event as well as in the case where a change larger than the predetermined threshold in photocurrent has been detected as an event.

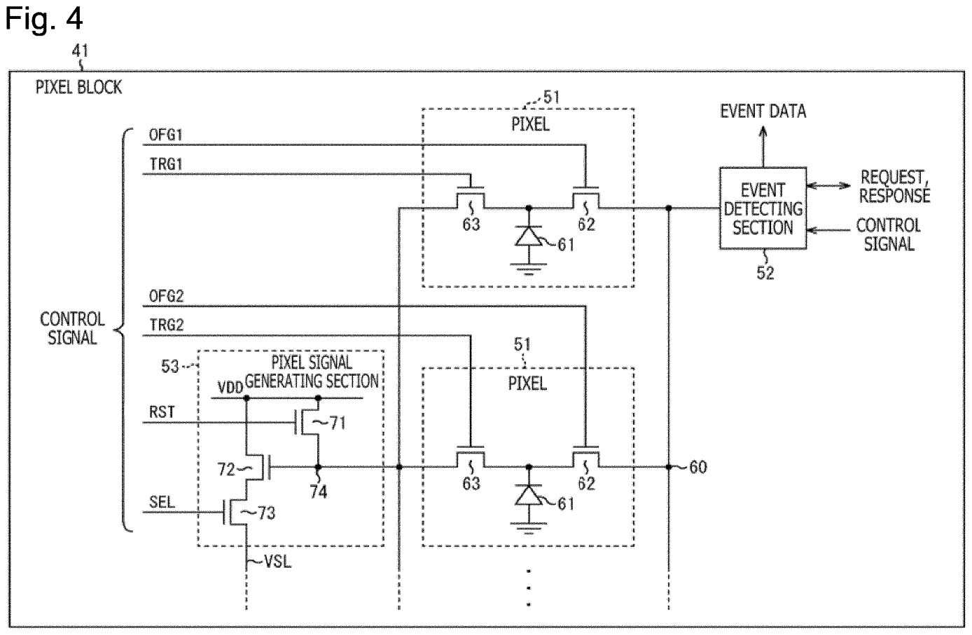

FIG. 4 is a circuit diagram illustrating a configuration example of the pixel block 41.

The pixel block 41 includes, as described with reference to FIG. 3, the pixels 51, the event detecting section 52, and the pixel signal generating section 53.

The pixel 51 includes a photoelectric conversion element 61 and transfer transistors 62 and 63.

The photoelectric conversion element 61 includes, for example, a PD (Photodiode). The photoelectric conversion element 61 receives incident light and performs photoelectric conversion to generate charges.

The transfer transistor 62 includes, for example, an N (Negative)-type MOS (Metal-Oxide-Semiconductor) FET (Field Effect Transistor). The transfer transistor 62 of the n-th pixel 51 of the I×J pixels 51 in the pixel block 41 is turned on or off in response to a control signal OFGn supplied from the driving section 32 (FIG. 2). When the transfer transistor 62 is turned on, charges generated in the photoelectric conversion element 61 are transferred (supplied) to the event detecting section 52, as a photocurrent.

The transfer transistor 63 includes, for example, an N-type MOSFET. The transfer transistor 63 of the n-th pixel 51 of the I×J pixels 51 in the pixel block 41 is turned on or off in response to a control signal TRGn supplied from the driving section 32. When the transfer transistor 63 is turned on, charges generated in the photoelectric conversion element 61 are transferred to an FD 74 of the pixel signal generating section 53.

The I×J pixels 51 in the pixel block 41 are connected to the event detecting section 52 of the pixel block 41 through nodes 60. Thus, photocurrents generated in (the photoelectric conversion elements 61 of) the pixels 51 are supplied to the event detecting section 52 through the nodes 60. As a result, the event detecting section 52 receives the sum of photocurrents from all the pixels 51 in the pixel block 41. Thus, the event detecting section 52 detects, as an event, a change in sum of photocurrents supplied from the I×J pixels 51 in the pixel block 41.

The pixel signal generating section 53 includes a reset transistor 71, an amplification transistor 72, a selection transistor 73, and the FD (Floating Diffusion) 74.

The reset transistor 71, the amplification transistor 72, and the selection transistor 73 include, for example, N-type MOSFETs.

The reset transistor 71 is turned on or off in response to a control signal RST supplied from the driving section 32 (FIG. 2). When the reset transistor 71 is turned on, the FD 74 is connected to a power supply VDD, and charges accumulated in the FD 74 are thus discharged to the power supply VDD. With this, the FD 74 is reset.

The amplification transistor 72 has a gate connected to the FD 74, a drain connected to the power supply VDD, and a source connected to the VSL through the selection transistor 73. The amplification transistor 72 is a source follower and outputs a voltage (electrical signal) corresponding to the voltage of the FD 74 supplied to the gate to the VSL through the selection transistor 73.

The selection transistor 73 is turned on or off in response to a control signal SEL supplied from the driving section 32. When the selection transistor 73 is turned on, a voltage corresponding to the voltage of the FD 74 from the amplification transistor 72 is output to the VSL.

The FD 74 accumulates charges transferred from the photoelectric conversion elements 61 of the pixels 51 through the transfer transistors 63, and converts the charges to voltages.

With regard to the pixels 51 and the pixel signal generating section 53, which are configured as described above, the driving section 32 turns on the transfer transistors 62 with control signals OFGn, so that the transfer transistors 62 supply, to the event detecting section 52, photocurrents based on charges generated in the photoelectric conversion elements 61 of the pixels 51. With this, the event detecting section 52 receives a current that is the sum of the photocurrents from all the pixels 51 in the pixel block 41, which might also be only a single pixel.

When the event detecting section 52 detects, as an event, a change in photocurrent (sum of photocurrents) in the pixel block 41, the driving section 32 turns off the transfer transistors 62 of all the pixels 51 in the pixel block 41, to thereby stop the supply of the photocurrents to the event detecting section 52. Then, the driving section 32 sequentially turns on, with the control signals TRGn, the transfer transistors 63 of the pixels 51 in the pixel block 41 in which the event has been detected, so that the transfer transistors 63 transfers charges generated in the photoelectric conversion elements 61 to the FD 74. The FD 74 accumulates the charges transferred from (the photoelectric conversion elements 61 of) the pixels 51. Voltages corresponding to the charges accumulated in the FD 74 are output to the VSL, as pixel signals of the pixels 51, through the amplification transistor 72 and the selection transistor 73.

As described above, in the sensor section 21 (FIG. 2), only pixel signals of the pixels 51 in the pixel block 41 in which an event has been detected are sequentially output to the VSL. The pixel signals output to the VSL are supplied to the AD conversion section 34 to be subjected to AD conversion.

Here, in the pixels 51 in the pixel block 41, the transfer transistors 63 can be turned on not sequentially but simultaneously. In this case, the sum of pixel signals of all the pixels 51 in the pixel block 41 can be output.

In the pixel array section 31 of FIG. 3, the pixel block 41 includes one or more pixels 51, and the one or more pixels 51 share the event detecting section 52 and the pixel signal generating section 53. Thus, in the case where the pixel block 41 includes a plurality of pixels 51, the numbers of the event detecting sections 52 and the pixel signal generating sections 53 can be reduced as compared to a case where the event detecting section 52 and the pixel signal generating section 53 are provided for each of the pixels 51, with the result that the scale of the pixel array section 31 can be reduced.

Note that, in the case where the pixel block 41 includes a plurality of pixels 51, the event detecting section 52 can be provided for each of the pixels 51. In the case where the plurality of pixels 51 in the pixel block 41 share the event detecting section 52, events are detected in units of the pixel blocks 41. In the case where the event detecting section 52 is provided for each of the pixels 51, however, events can be detected in units of the pixels 51.

Yet, even in the case where the plurality of pixels 51 in the pixel block 41 share the single event detecting section 52, events can be detected in units of the pixels 51 when the transfer transistors 62 of the plurality of pixels 51 are temporarily turned on in a time-division manner.

Further, in a case where there is no need to output pixel signals, the pixel block 41 can be formed without the pixel signal generating section 53. In the case where the pixel block 41 is formed without the pixel signal generating section 53, the sensor section 21 can be formed without the AD conversion section 34 and the transfer transistors 63. In this case, the scale of the sensor section 21 can be reduced. The sensor will then output the address of the pixel (block) in which the event occurred, if necessary with a time stamp.

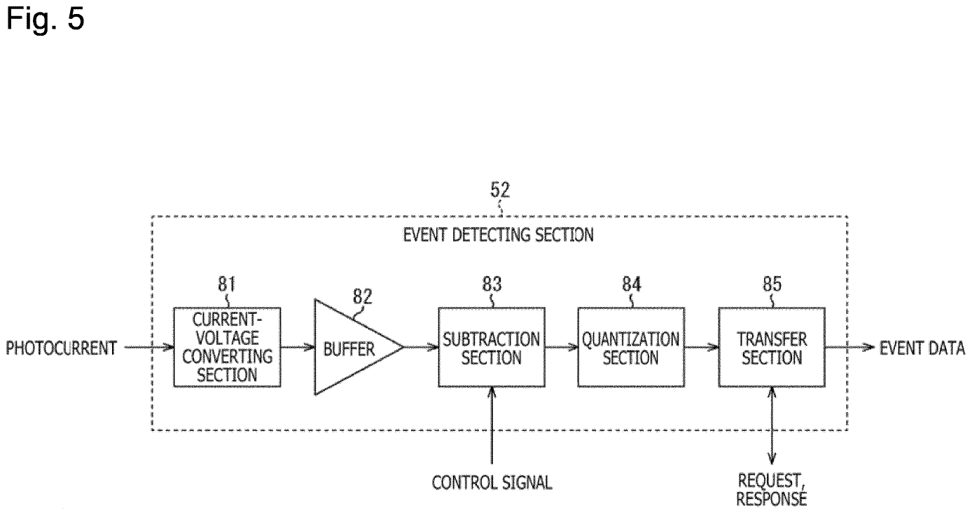

FIG. 5 is a block diagram illustrating a configuration example of the event detecting section 52 of FIG. 3.

The event detecting section 52 includes a current-voltage converting section 81, a buffer 82, a subtraction section 83, a quantization section 84, and a transfer section 85.

The current-voltage converting section 81 converts (a sum of) photocurrents from the pixels 51 to voltages corresponding to the logarithms of the photocurrents (hereinafter also referred to as a “photovoltage”) and supplies the voltages to the buffer 82.

The buffer 82 buffers photovoltages from the current-voltage converting section 81 and supplies the resultant to the subtraction section 83.

The subtraction section 83 calculates, at a timing instructed by a row driving signal that is a control signal from the driving section 32, a difference between the current photovoltage and a photovoltage at a timing slightly shifted from the current time, and supplies a difference signal corresponding to the difference to the quantization section 84.

The quantization section 84 quantizes difference signals from the subtraction section 83 to digital signals and supplies the quantized values of the difference signals to the transfer section 85 as event data.

The transfer section 85 transfers (outputs), on the basis of event data from the quantization section 84, the event data to the output section 35. That is, the transfer section 85 supplies a request for requesting the output of the event data to the arbiter 33. Then, when receiving a response indicating event data output permission to the request from the arbiter 33, the transfer section 85 outputs the event data to the output section 35.

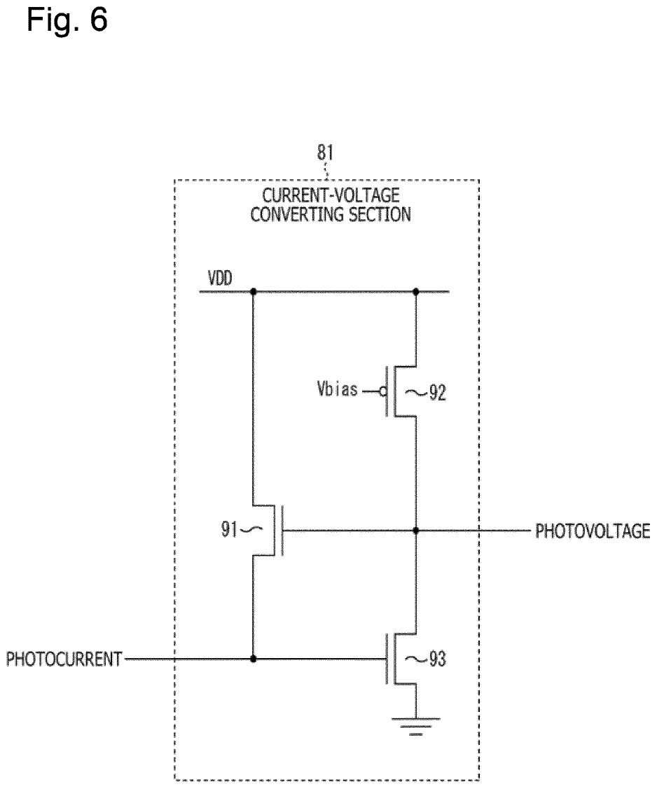

FIG. 6 is a circuit diagram illustrating a configuration example of the current-voltage converting section 81 of FIG. 5.

The current-voltage converting section 81 includes transistors 91 to 93. As the transistors 91 and 93, for example, N-type MOSFETs can be employed. As the transistor 92, for example, a P-type MOSFET can be employed.

The transistor 91 has a source connected to the gate of the transistor 93, and a photocurrent is supplied from the pixel 51 to the connecting point between the source of the transistor 91 and the gate of the transistor 93. The transistor 91 has a drain connected to the power supply VDD and a gate connected to the drain of the transistor 93.

The transistor 92 has a source connected to the power supply VDD and a drain connected to the connecting point between the gate of the transistor 91 and the drain of the transistor 93. A predetermined bias voltage Vbias is applied to the gate of the transistor 92. With the bias voltage Vbias, the transistor 92 is turned on or off, and the operation of the current-voltage converting section 81 is turned on or off depending on whether the transistor 92 is turned on or off.

The source of the transistor 93 is grounded.

In the current-voltage converting section 81, the transistor 91 has the drain connected on the power supply VDD side. The source of the transistor 91 is connected to the pixels 51 (FIG. 4), so that photocurrents based on charges generated in the photoelectric conversion elements 61 of the pixels 51 flow through the transistor 91 (from the drain to the source). The transistor 91 operates in a subthreshold region, and at the gate of the transistor 91, photovoltages corresponding to the logarithms of the photocurrents flowing through the transistor 91 are generated. As described above, in the current-voltage converting section 81, the transistor 91 converts photocurrents from the pixels 51 to photovoltages corresponding to the logarithms of the photocurrents.

In the current-voltage converting section 81, the transistor 91 has the gate connected to the connecting point between the drain of the transistor 92 and the drain of the transistor 93, and the photovoltages are output from the connecting point in question.

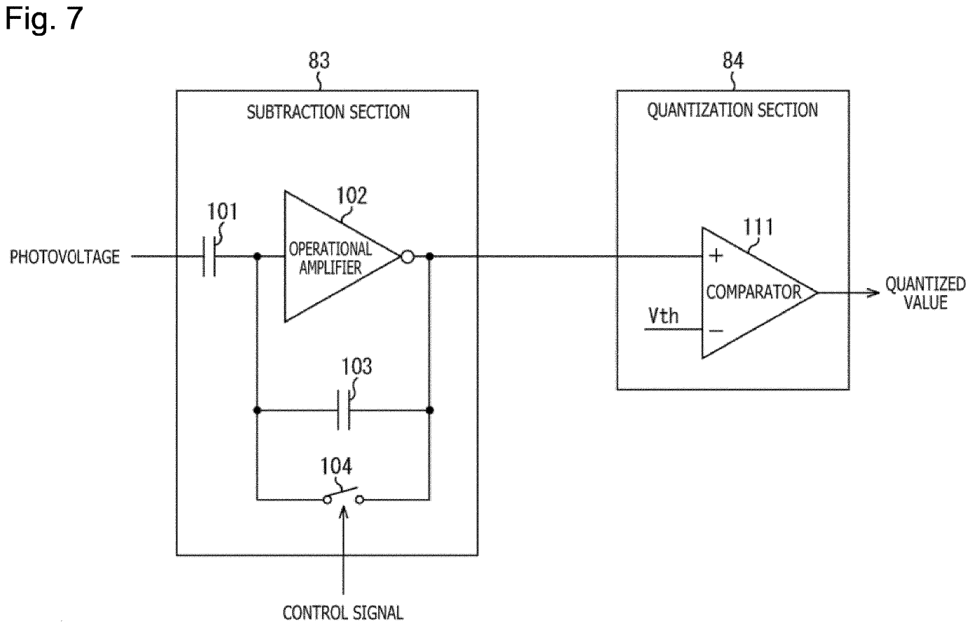

FIG. 7 is a circuit diagram illustrating configuration examples of the subtraction section 83 and the quantization section 84 of FIG. 5.

The subtraction section 83 includes a capacitor 101, an operational amplifier 102, a capacitor 103, and a switch 104. The quantization section 84 includes a comparator 111.

The capacitor 101 has one end connected to the output terminal of the buffer 82 (FIG. 5) and the other end connected to the input terminal (inverting input terminal) of the operational amplifier 102. Thus, photovoltages are input to the input terminal of the operational amplifier 102 through the capacitor 101.

The operational amplifier 102 has an output terminal connected to the non-inverting input terminal (+) of the comparator 111.

The capacitor 103 has one end connected to the input terminal of the operational amplifier 102 and the other end connected to the output terminal of the operational amplifier 102.

The switch 104 is connected to the capacitor 103 to switch the connections between the ends of the capacitor 103. The switch 104 is turned on or off in response to a row driving signal that is a control signal from the driving section 32, to thereby switch the connections between the ends of the capacitor 103.

A photovoltage on the buffer 82 (FIG. 5) side of the capacitor 101 when the switch 104 is on is denoted by Vinit, and the capacitance (electrostatic capacitance) of the capacitor 101 is denoted by C1. The input terminal of the operational amplifier 102 serves as a virtual ground terminal, and a charge Qinit that is accumulated in the capacitor 101 in the case where the switch 104 is on is expressed by Expression (1).

$$Qinit = C 1 \times Vinit \qquad ( 1 )$$

Further, in the case where the switch 104 is on, the connection between the ends of the capacitor 103 is cut (short-circuited), so that no charge is accumulated in the capacitor 103.

When a photovoltage on the buffer 82 (FIG. 5) side of the capacitor 101 in the case where the switch 104 has thereafter been turned off is denoted by Vafter, a charge Qafter that is accumulated in the capacitor 101 in the case where the switch 104 is off is expressed by Expression (2).

$$Qafter = C 1 \times Vafter \qquad ( 2 )$$

When the capacitance of the capacitor 103 is denoted by C2 and the output voltage of the operational amplifier 102 is denoted by Vout, a charge Q2 that is accumulated in the capacitor 103 is expressed by Expression (3).

$$Q 2 = - C 2 \times Vout \qquad ( 3 )$$

Since the total amount of charges in the capacitors 101 and 103 does not change before and after the switch 104 is turned off, Expression (4) is established.

$$Qinit = Qafter + Q 2 \qquad ( 4 )$$

When Expression (1) to Expression (3) are substituted for Expression (4), Expression (5) is obtained.

$$Vout = - ( C 1 / C 2 ) \times ( Vafter - Vinit ) \qquad ( 5 )$$

With Expression (5), the subtraction section 83 subtracts the photovoltage Vinit from the photovoltage Vafter, that is, calculates the difference signal (Vout) corresponding to a difference Vafter−Vinit between the photovoltages Vafter and Vinit. With Expression (5), the subtraction gain of the subtraction section 83 is C1/C2. Since the maximum gain is normally desired, C1 is preferably set to a large value and C2 is preferably set to a small value. Meanwhile, when C2 is too small, kTC noise increases, resulting in a risk of deteriorated noise characteristics. Thus, the capacitance C2 can only be reduced in a range that achieves acceptable noise. Further, since the pixel blocks 41 each have installed therein the event detecting section 52 including the subtraction section 83, the capacitances C1 and C2 have space constraints. In consideration of these matters, the values of the capacitances C1 and C2 are determined.

The comparator 111 compares a difference signal from the subtraction section 83 with a predetermined threshold (voltage) Vth (>0) applied to the inverting input terminal (−), thereby quantizing the difference signal. The comparator 111 outputs the quantized value obtained by the quantization to the transfer section 85 as event data.

For example, in a case where a difference signal is larger than the threshold Vth, the comparator 111 outputs an H (High) level indicating 1, as event data indicating the occurrence of an event. In a case where a difference signal is not larger than the threshold Vth, the comparator 111 outputs an L (Low) level indicating 0, as event data indicating that no event has occurred.

The transfer section 85 supplies a request to the arbiter 33 in a case where it is confirmed on the basis of event data from the quantization section 84 that a change in light amount that is an event has occurred, that is, in the case where the difference signal (Vout) is larger than the threshold Vth. When receiving a response indicating event data output permission, the transfer section 85 outputs the event data indicating the occurrence of the event (for example, H level) to the output section 35.

The output section 35 includes, in event data from the transfer section 85, location/address information regarding (the pixel block 41 including) the pixel 51 in which an event indicated by the event data has occurred and time point information indicating a time point at which the event has occurred, and further, as needed, the polarity of a change in light amount that is the event, i.e. whether the intensity did increase or decrease. The output section 35 outputs the event data.

As the data format of event data including location information regarding the pixel 51 in which an event has occurred, time point information indicating a time point at which the event has occurred, and the polarity of a change in light amount that is the event, for example, the data format called “AER (Address Event Representation)” can be employed.

Note that, a gain A of the entire event detecting section 52 is expressed by the following expression where the gain of the current-voltage converting section 81 is denoted by CG_{log} and the gain of the buffer 82 is 1.

$$A = {CG}_{log} C 1 / C 2 ( \sum {i}_{photo \_ n} ) \qquad ( 6 )$$

Here, iₚₕₒₜₒ_n denotes a photocurrent of the n-th pixel 51 of the I×J pixels 51 in the pixel block 41. In Expression (6), Σ denotes the summation of n that takes integers ranging from 1 to I×J.

Note that, the pixel 51 can receive any light as incident light with an optical filter through which predetermined light passes, such as a color filter. For example, in a case where the pixel 51 receives visible light as incident light, event data indicates the occurrence of changes in pixel value in images including visible objects. Further, for example, in a case where the pixel 51 receives, as incident light, infrared light, millimeter waves, or the like for ranging, event data indicates the occurrence of changes in distances to objects. In addition, for example, in a case where the pixel 51 receives infrared light for temperature measurement, as incident light, event data indicates the occurrence of changes in temperature of objects. In the present embodiment, the pixel 51 is assumed to receive visible light as incident light.

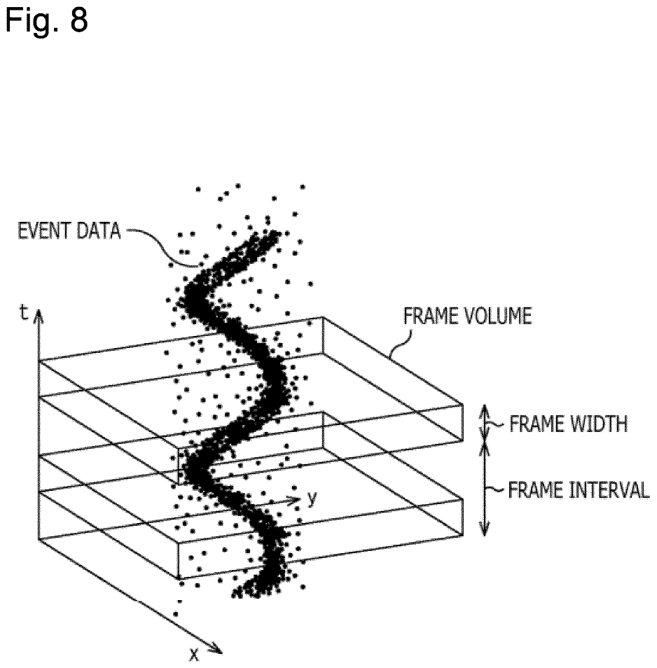

FIG. 8 is a diagram illustrating an example of a frame data generation method based on event data.

The logic section 22 sets a frame interval and a frame width on the basis of an externally input command, for example. Here, the frame interval represents the interval of frames of frame data that is generated on the basis of event data. The frame width represents the time width of event data that is used for generating frame data on a single frame. A frame interval and a frame width that are set by the logic section 22 are also referred to as a “set frame interval” and a “set frame width,” respectively.

The logic section 22 generates, on the basis of the set frame interval, the set frame width, and event data from the sensor section 21, frame data that is image data in a frame format, to thereby convert the event data to the frame data.

That is, the logic section 22 generates, in each set frame interval, frame data on the basis of event data in the set frame width from the beginning of the set frame interval.

Here, it is assumed that event data includes time point information tᵢ indicating a time point at which an event has occurred (hereinafter also referred to as an “event time point”) and coordinates (x, y) serving as location information regarding (the pixel block 41 including) the pixel 51 in which the event has occurred (hereinafter also referred to as an “event location”).

In FIG. 8, in a three-dimensional space (time and space) with the x axis, the y axis, and the time axis t, points representing event data are plotted on the basis of the event time point t and the event location (coordinates) (x, y) included in the event data.

That is, when a location (x, y, t) on the three-dimensional space indicated by the event time point t and the event location (x, y) included in event data is regarded as the space-time location of an event, in FIG. 8, the points representing the event data are plotted on the space-time locations (x, y, t) of the events.

The logic section 22 starts to generate frame data on the basis of event data by using, as a generation start time point at which frame data generation starts, a predetermined time point, for example, a time point at which frame data generation is externally instructed or a time point at which the sensor device 10 is powered on.

Here, cuboids each having the set frame width in the direction of the time axis t in the set frame intervals, which appear from the generation start time point, are referred to as a “frame volume.” The size of the frame volume in the x-axis direction or the y-axis direction is equal to the number of the pixel blocks 41 or the pixels 51 in the x-axis direction or the y-axis direction, for example.

The logic section 22 generates, in each set frame interval, frame data on a single frame on the basis of event data in the frame volume having the set frame width from the beginning of the set frame interval.

Frame data can be generated by, for example, setting white to a pixel (pixel value) in a frame at the event location (x, y) included in event data and setting a predetermined color such as gray to pixels at other locations in the frame.

Besides, in a case where event data includes the polarity of a change in light amount that is an event, frame data can be generated in consideration of the polarity included in the event data. For example, white can be set to pixels in the case a positive polarity, while black can be set to pixels in the case of a negative polarity.

In addition, in the case where pixel signals of the pixels 51 are also output when event data is output as described with reference to FIG. 3 and FIG. 4, frame data can be generated on the basis of the event data by using the pixel signals of the pixels 51. That is, frame data can be generated by setting, in a frame, a pixel at the event location (x, y) (in a block corresponding to the pixel block 41) included in event data to a pixel signal of the pixel 51 at the location (x, y) and setting a predetermined color such as gray to pixels at other locations.

Note that, in the frame volume, there are a plurality of pieces of event data that are different in the event time point t but the same in the event location (x, y) in some cases. In this case, for example, event data at the latest or oldest event time point t can be prioritized. Further, in the case where event data includes polarities, the polarities of a plurality of pieces of event data that are different in the event time point t but the same in the event location (x, y) can be added together, and a pixel value based on the added value obtained by the addition can be set to a pixel at the event location (x, y).

Here, in a case where the frame width and the frame interval are the same, the frame volumes are adjacent to each other without any gap. Further, in a case where the frame interval is larger than the frame width, the frame volumes are arranged with gaps. In a case where the frame width is larger than the frame interval, the frame volumes are arranged to be partly overlapped with each other.

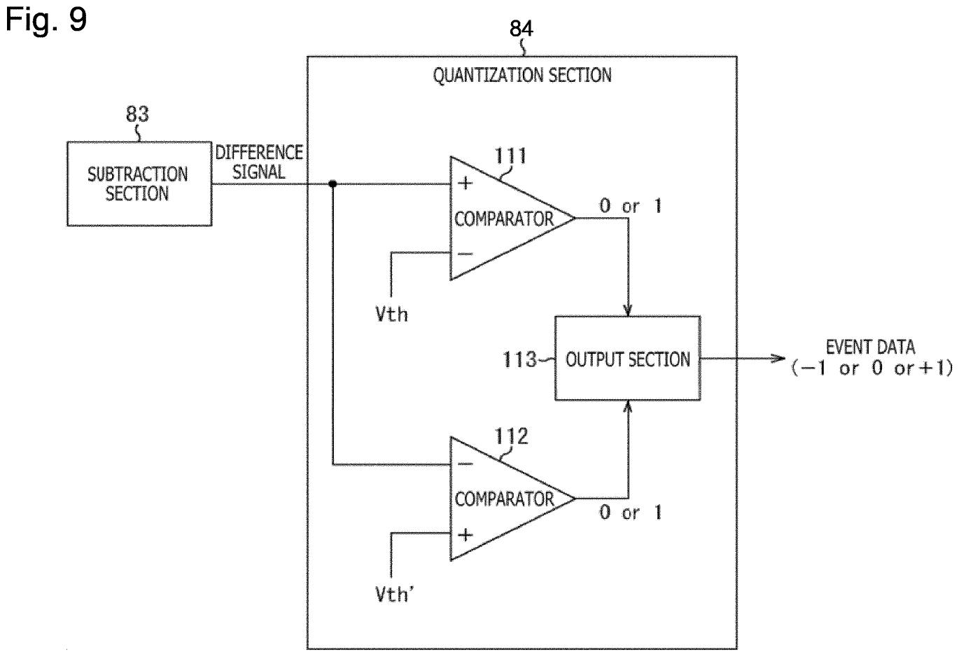

FIG. 9 is a block diagram illustrating another configuration example of the quantization section 84 of FIG. 5.

Note that, in FIG. 9, parts corresponding to those in the case of FIG. 7 are denoted by the same reference signs, and the description thereof is omitted as appropriate below.

In FIG. 9, the quantization section 84 includes comparators 111 and 112 and an output section 113.

Thus, the quantization section 84 of FIG. 9 is similar to the case of FIG. 7 in including the comparator 111. However, the quantization section 84 of FIG. 9 is different from the case of FIG. 7 in newly including the comparator 112 and the output section 113.

The event detecting section 52 (FIG. 5) including the quantization section 84 of FIG. 9 detects, in addition to events, the polarities of changes in light amount that are events.

In the quantization section 84 of FIG. 9, the comparator 111 outputs, in the case where a difference signal is larger than the threshold Vth, the H level indicating 1, as event data indicating the occurrence of an event having the positive polarity. The comparator 111 outputs, in the case where a difference signal is not larger than the threshold Vth, the L level indicating 0, as event data indicating that no event having the positive polarity has occurred.

Further, in the quantization section 84 of FIG. 9, a threshold Vth′ (<Vth) is supplied to the non-inverting input terminal (+) of the comparator 112, and difference signals are supplied to the inverting input terminal (−) of the comparator 112 from the subtraction section 83. Here, for the sake of simple description, it is assumed that the threshold Vth′ is equal to −Vth, for example, which needs however not to be the case.

The comparator 112 compares a difference signal from the subtraction section 83 with the threshold Vth′ applied to the inverting input terminal (−), thereby quantizing the difference signal. The comparator 112 outputs, as event data, the quantized value obtained by the quantization.

For example, in a case where a difference signal is smaller than the threshold Vth′ (the absolute value of the difference signal having a negative value is larger than the threshold Vth), the comparator 112 outputs the H level indicating 1, as event data indicating the occurrence of an event having the negative polarity. Further, in a case where a difference signal is not smaller than the threshold Vth′ (the absolute value of the difference signal having a negative value is not larger than the threshold Vth), the comparator 112 outputs the L level indicating 0, as event data indicating that no event having the negative polarity has occurred.

The output section 113 outputs, on the basis of event data output from the comparators 111 and 112, event data indicating the occurrence of an event having the positive polarity, event data indicating the occurrence of an event having the negative polarity, or event data indicating that no event has occurred to the transfer section 85.

For example, the output section 113 outputs, in a case where event data from the comparator 111 is the H level indicating 1, +V volts indicating +1, as event data indicating the occurrence of an event having the positive polarity, to the transfer section 85. Further, the output section 113 outputs, in a case where event data from the comparator 112 is the H level indicating 1, −V volts indicating −1, as event data indicating the occurrence of an event having the negative polarity, to the transfer section 85. In addition, the output section 113 outputs, in a case where each event data from the comparators 111 and 112 is the L level indicating 0, 0 volts (GND level) indicating 0, as event data indicating that no event has occurred, to the transfer section 85.

The transfer section 85 supplies a request to the arbiter 33 in the case where it is confirmed on the basis of event data from the output section 113 of the quantization section 84 that a change in light amount that is an event having the positive polarity or the negative polarity has occurred. After receiving a response indicating event data output permission, the transfer section 85 outputs event data indicating the occurrence of the event having the positive polarity or the negative polarity (+V volts indicating 1 or −V volts indicating −1) to the output section 35.

Preferably, the quantization section 84 has a configuration as illustrated in FIG. 9.

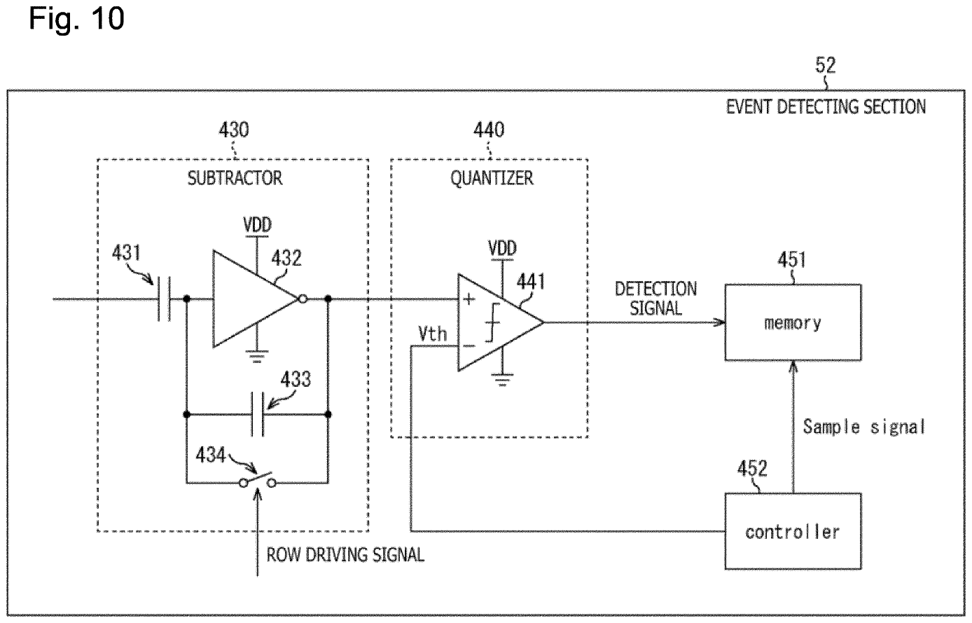

FIG. 10 is a diagram illustrating another configuration example of the event detecting section 52.

In FIG. 10, the event detecting section 52 includes a subtractor 430, a quantizer 440, a memory 451, and a controller 452. The subtractor 430 and the quantizer 440 correspond to the subtraction section 83 and the quantization section 84, respectively.

Note that, in FIG. 10, the event detecting section 52 further includes blocks corresponding to the current-voltage converting section 81 and the buffer 82, but the illustrations of the blocks are omitted in FIG. 10.

The subtractor 430 includes a capacitor 431, an operational amplifier 432, a capacitor 433, and a switch 434. The capacitor 431, the operational amplifier 432, the capacitor 433, and the switch 434 correspond to the capacitor 101, the operational amplifier 102, the capacitor 103, and the switch 104, respectively.

The quantizer 440 includes a comparator 441. The comparator 441 corresponds to the comparator 111.

The comparator 441 compares a voltage signal (difference signal) from the subtractor 430 with the predetermined threshold voltage Vth applied to the inverting input terminal (−). The comparator 441 outputs a signal indicating the comparison result, as a detection signal (quantized value).

The voltage signal from the subtractor 430 may be input to the input terminal (−) of the comparator 441, and the predetermined threshold voltage Vth may be input to the input terminal (+) of the comparator 441.

The controller 452 supplies the predetermined threshold voltage Vth applied to the inverting input terminal (−) of the comparator 441. The threshold voltage Vth which is supplied may be changed in a time-division manner. For example, the controller 452 supplies a threshold voltage Vth1 corresponding to ON events (for example, positive changes in photocurrent) and a threshold voltage Vth2 corresponding to OFF events (for example, negative changes in photocurrent) at different timings to allow the single comparator to detect a plurality of types of address events (events).

The memory 451 accumulates output from the comparator 441 on the basis of Sample signals supplied from the controller 452. The memory 451 may be a sampling circuit, such as a switch, plastic, or capacitor, or a digital memory circuit, such as a latch or flip-flop. For example, the memory 451 may hold, in a period in which the threshold voltage Vth2 corresponding to OFF events is supplied to the inverting input terminal (−) of the comparator 441, the result of comparison by the comparator 441 using the threshold voltage Vth1 corresponding to ON events. Note that, the memory 451 may be omitted, may be provided inside the pixel (pixel block 41), or may be provided outside the pixel.

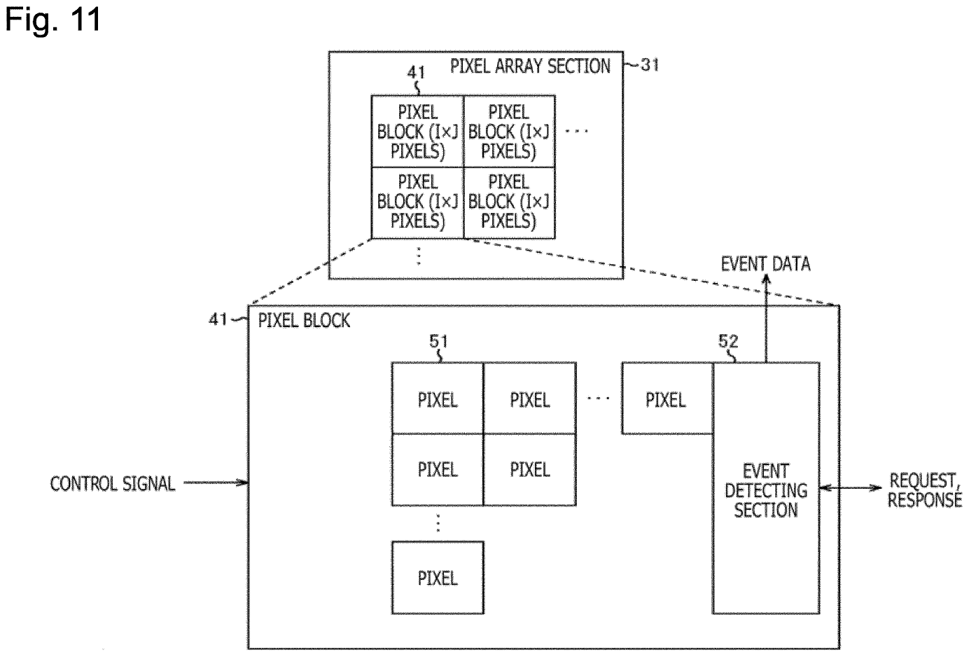

FIG. 11 is a block diagram illustrating another configuration example of the pixel array section 31 of FIG. 2.

Note that, in FIG. 11, parts corresponding to those in the case of FIG. 3 are denoted by the same reference signs, and the description thereof is omitted as appropriate below.

In FIG. 11, the pixel array section 31 includes the plurality of pixel blocks 41. The pixel block 41 includes the I×J pixels 51 that are one or more pixels and the event detecting section 52.

Thus, the pixel array section 31 of FIG. 11 is similar to the case of FIG. 3 in that the pixel array section 31 includes the plurality of pixel blocks 41 and that the pixel block 41 includes one or more pixels 51 and the event detecting section 52. However, the pixel array section 31 of FIG. 11 is different from the case of FIG. 3 in that the pixel block 41 does not include the pixel signal generating section 53.

As described above, in the pixel array section 31 of FIG. 11, the pixel block 41 does not include the pixel signal generating section 53, so that the sensor section 21 (FIG. 2) can be formed without the AD conversion section 34.

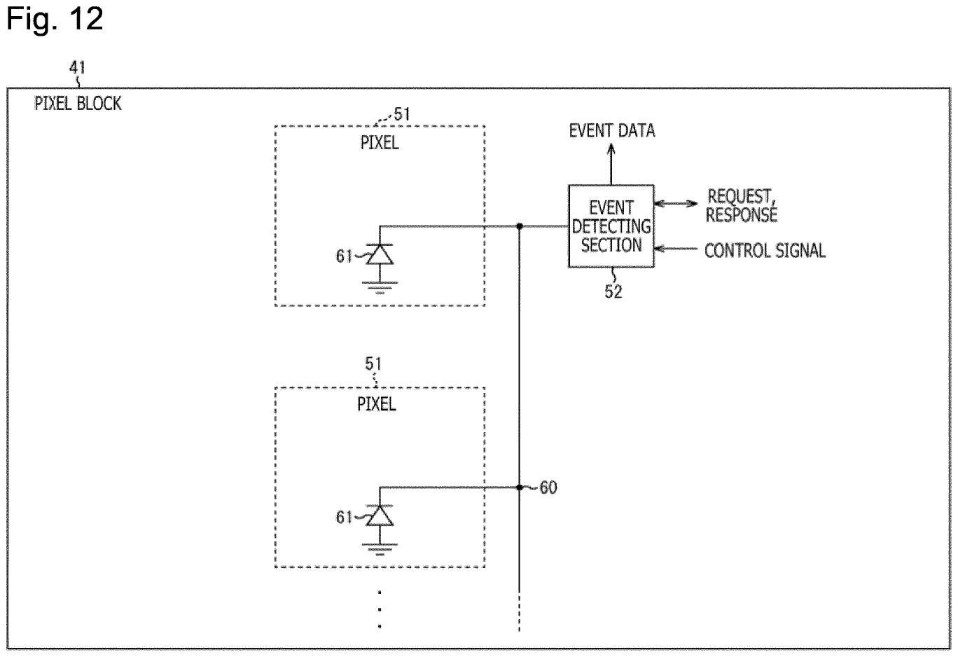

FIG. 12 is a circuit diagram illustrating a configuration example of the pixel block 41 of FIG. 11.

As described with reference to FIG. 11, the pixel block 41 includes the pixels 51 and the event detecting section 52, but does not include the pixel signal generating section 53.

In this case, the pixel 51 can only include the photoelectric conversion element 61 without the transfer transistors 62 and 63.

Note that, in the case where the pixel 51 has the configuration illustrated in FIG. 12, the event detecting section 52 can output a voltage corresponding to a photocurrent from the pixel 51, as a pixel signal.

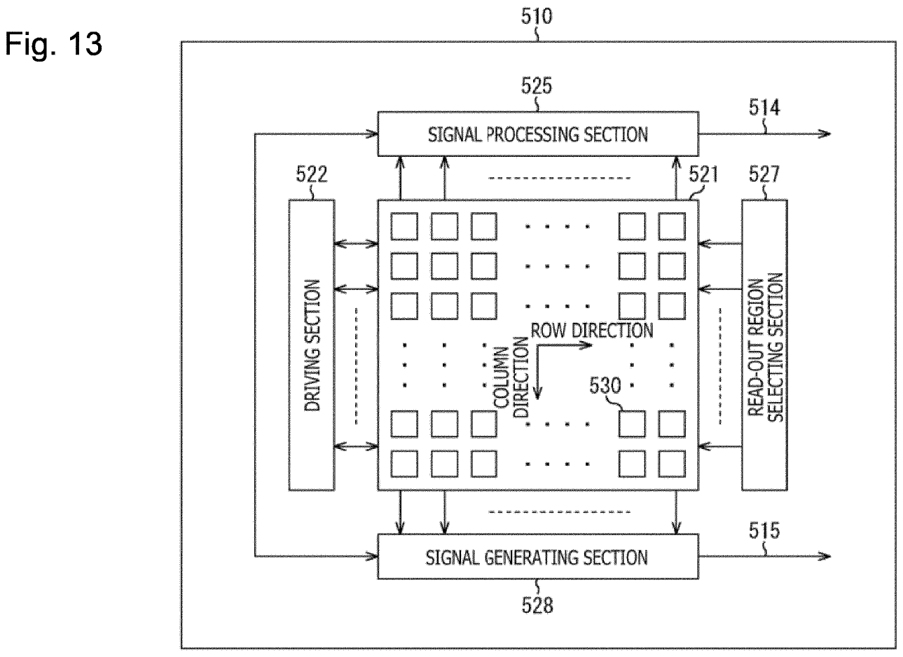

FIG. 13 is a block diagram illustrating a configuration example of a scan type imaging device which may be used as an EVS.

As illustrated in FIG. 13, an imaging device 510 includes a pixel array section 521, a driving section 522, a signal processing section 525, a read-out region selecting section 527, and an optional signal generating section 528.

The pixel array section 521 includes a plurality of pixels 530. The plurality of pixels 530 each output an output signal in response to a selection signal from the read-out region selecting section 527. The plurality of pixels 530 can each include an in-pixel quantizer as illustrated in FIG. 10, for example. The plurality of pixels 530 outputs output signals corresponding to the amounts of change in light intensity. The plurality of pixels 530 may be two-dimensionally disposed in a matrix as illustrated in FIG. 13.

The driving section 522 drives the plurality of pixels 530, so that the pixels 530 output pixel signals generated in the pixels 530 to the signal processing section 525 through an output line 514. Note that, the driving section 522 and the signal processing section 525 are circuit sections for acquiring grayscale information.

The read-out region selecting section 527 selects some of the plurality of pixels 530 included in the pixel array section 521. For example, the read-out region selecting section 527 selects one or a plurality of rows included in the two-dimensional matrix structure corresponding to the pixel array section 521. The read-out region selecting section 527 sequentially selects one or a plurality of rows on the basis of a cycle set in advance, e.g. based on a rolling shutter. Further, the read-out region selecting section 527 may determine a selection region on the basis of requests from the pixels 530 in the pixel array section 521.

The optional signal generating section 528 may generate, on the basis of output signals of the pixels 530 selected by the read-out region selecting section 527, event signals corresponding to active pixels in which events have been detected of the selected pixels 530. The events mean an event that the intensity of light changes. The active pixels mean the pixel 530 in which the amount of change in light intensity corresponding to an output signal exceeds or falls below a threshold set in advance. For example, the signal generating section 528 compares output signals from the pixels 530 with a reference signal, and detects, as an active pixel, a pixel that outputs an output signal larger or smaller than the reference signal. The signal generating section 528 generates an event signal (event data) corresponding to the active pixel.

The signal generating section 528 can include, for example, a column selecting circuit configured to arbitrate signals input to the signal generating section 528. Further, the signal generating section 528 can output not only information regarding active pixels in which events have been detected, but also information regarding non-active pixels in which no event has been detected.

The signal generating section 528 outputs, through an output line 515, address information and timestamp information (for example, (X, Y, T)) regarding the active pixels in which the events have been detected. However, the data that is output from the signal generating section 528 may not only be the address information and the timestamp information, but also information in a frame format (for example, (0, 0, 1, 0, . . . )).

In the following description reference will mainly be made to sensor devices of the EVS type as described above in order to ease the description and to cover an important application example. However, the principles explained below apply just as well to general sensor devices that show a fixed pattern noise, FPN.

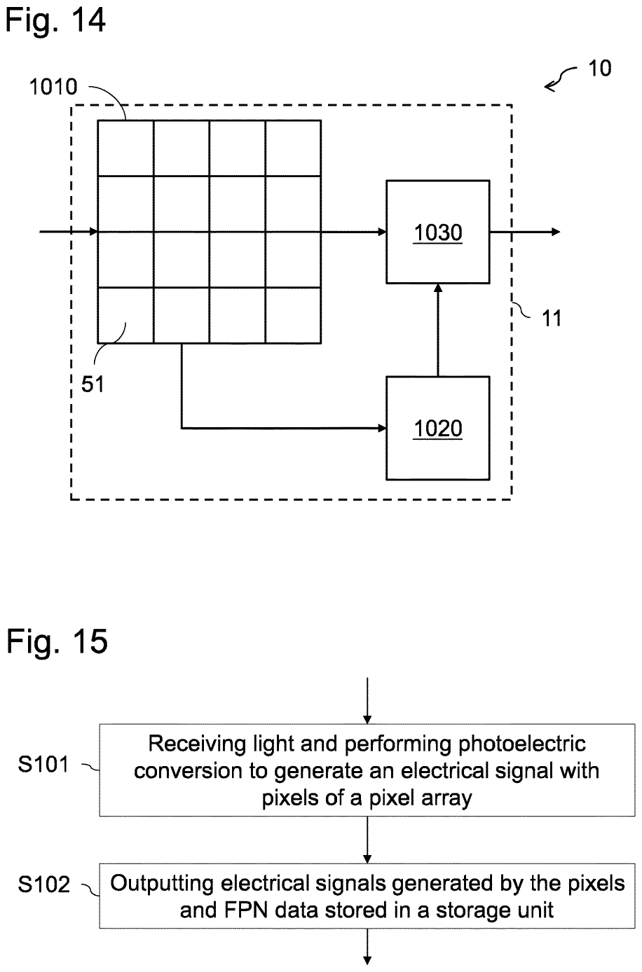

FIG. 14 shows a schematic illustration of a sensor device 10 that comprises a pixel array 1010, a storage unit 1020, and an output unit 1030.

The pixel array 1010 comprises a plurality of pixels 51 that are each configured to receive light and to perform photoelectric conversion to generate an electrical signal. In particular, the pixels 51 may be event detection pixels that are each configured to generate event data based on the received light, which event data indicate as an event the occurrence of an intensity change of the light above an event detection threshold. Thus, the pixel array 1010 may constitute an EVS as described above with respect to FIGS. 1 to 13. The pixel array 1010 may be formed solely of event detection pixels or may be a hybrid sensor array comprising a mixture of event detection pixels and pixels that generate an electrical signal that indicates the absolute intensity of the received light. Also, the pixels 51 of the pixel array 1010 may have the ability to generate both, event data and intensity data, as was described above with respect to FIGS. 3 and 4.

The storage unit 1020 may be formed by any in principle known memory device and may in particular be a non-volatile memory. The storage unit 1020 is configured to store fixed pattern noise, FPN, data that indicate FPN of the pixel array 1010. That is, on the storage unit 1020 data are fixed that parametrize the FPN of the pixel array 1010. In particular, the FPN data allow to understand the FPN distribution on the pixel array 1010, i.e. mismatches between pixels with respect to offsets and/or gains, and/or mismatches caused by inevitable manufacturing errors, which result in slightly varying outputs of the pixels 51 although the same input was received by the pixels.

For example, the FPN data may be constituted by calibrated electrical signals of the pixels 51 obtained when imaging a predetermined calibration scene 1015 as illustrated in FIG. 17. There, it is shown how a calibration screen of uniform color and brightness causes due to the FPN at each pixel 51 a slightly varying electrical signal (illustrated by FPN distribution A in FIG. 17). Thus, in this simple example, each pixel 51 is assigned a FPN value that represents the response of the pixel 51 to capturing the calibration scene 1015. These FPN values are stored as FPN data in the storage unit 1020. However, in order to save memory and ease further processing of the FPN data, it is also possible to generate the FPN data by compressing the FPN values obtained by capturing the calibration scene 1015. Thus, it is tried to extract and quantify from the FPN values essential features that are sufficient to represent the FPN of the entire pixel array 1010. An example how to do this will be discussed below.

The output unit 1030 of the sensor device 10 may in principle be configured as known from the prior art. The output unit 1030 must be configured to output the electrical signals generated by the pixels 51 together with the FPN data. That is, the sensor device 10 does not only provide the pixel data, but also the FPN data. Here, the FPN data can in principle be output once to a further processing stage where it is stored and used to correct errors in the pixel signals caused by FPN. However, the FPN data can also be output together with every output of pixel signals to form a single data set with the pixel signals that can then be fed into a consecutive processing stage. This means, for example, that the pixel signals of every frame are accompanied with the FPN data. Just the same, also event data that occurred during a given time period may be output together with the FPN data. Also, in an example where the FPN data are constituted by FPN values of each single pixel 51, it is possible to supplement the FPN value of the respective pixel 51 together with each event that is generated by this pixel 51. In this manner, the FPN data can be output in an asynchronous manner together with event data.

This output of pixel signals and FPN data provides information about the FPN of the pixel array 1010 that can be used in further processing stages to reduce or compensate the effects of the FPN on the pixel signals. In this manner, the effects of FPN can be reduced in post-processing stages. This makes manufacturing of sensor devices 10 less complicated, since the tolerance regarding FPN can be increased if effective post-processing is possible. Moreover, the complexity of the sensor devices 10 can be reduced, since on-chip correction methods like correlated double sampling or trimming (correction by application of gain and offset corrections) become superfluous or can be used with a lower level of precision. Thus, providing FPN data together with the pixel signals allows compensating the FPN by post-processing with less complex, and hence less costly, sensors that need less power, while achieving in principle similar or even improved results.

The basic method underlying the operation of the sensor device 10 is schematically illustrated in FIG. 15. At, S101 light is received by the pixels 51 and photoelectric conversion is performed by the pixels 51 to generate an electrical signal. At S102 the output unit 1030 outputs the electrical signals generated by the pixels 51 and the FPN data stored in the storage unit 1020.

Here, as illustrated in FIG. 14, the sensor device 10 may comprise (or may consist) of a single sensor chip 11 on which the pixel array 1010, the storage unit 1020, and the output unit 1030 are formed. In this configuration, there is no data transfer between different chips of the sensor device 10, which data transfer is constituted only be the pixel signals or only by the FPN data. In contrast, the pixel signals and the FPN data are forwarded from the pixel array 1010 and the storage unit 1020 to the output unit 1030 without leaving the chip 11. In this configuration, the output of the sensor chip 11 is therefore fixed to be a combination of the pixel signals and the FPN data. Of course, although placement of pixel array 1010, storage unit 1020 and output unit 1030 on a single chip/die/substrate is preferable, these components of the sensor device 10 may also be located on different chips/dies/substrates, as long as an output of pixel signals and FPN data is possible.

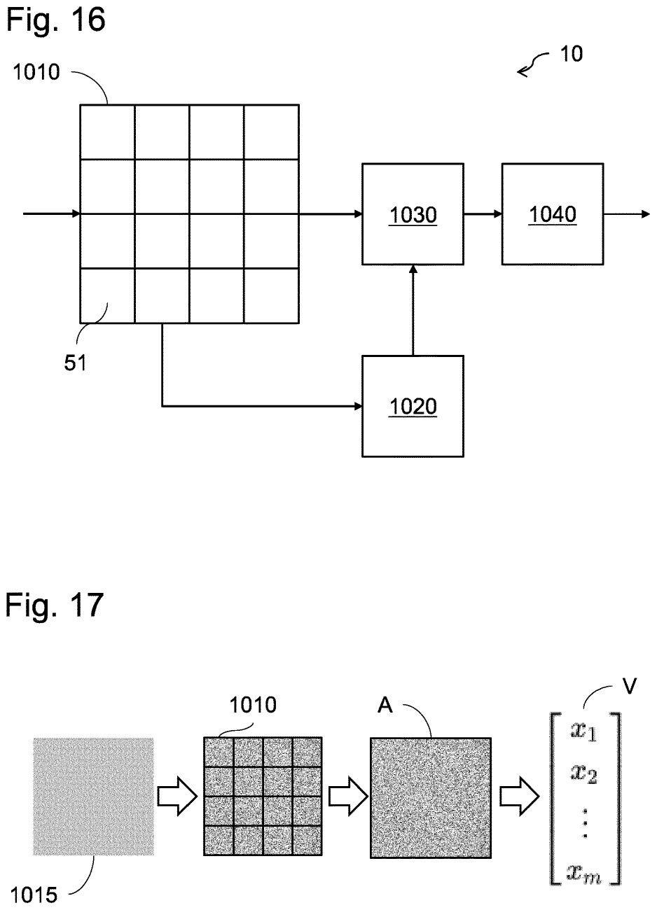

As illustrated in FIG. 16, the sensor device 10 may comprise a processing unit 1040 that is configured to receive the electrical signals and the FPN data from the output unit 1030 and to carry out a predetermined operation, preferably one of image generation, image classification, classification of movements, object classification, and image segmentation, based on the electrical signals and the FPN data.

That is, the pixel signals and the FPN data are forwarded to a processing unit 1040 for further processing. The processing unit 1040 may here be constituted by a commonly known device and may for example be a computer, a processor, a CPU, a GPU, a program or application running on a processor or the like. The processing unit 1040 may in principle carry out any kind of predetermined operation although of particular interest are operations in the field of image processing.

For example, the processing unit 1040 may operate on the pixel signals and the FPN data to generate an image that is free of the effects of the FPN of the pixel array 1010. Thus, the processing unit 1040 uses the FPN data to compensate such FPN effects in the pixel signals. Additionally or alternatively, the processing unit 1040 may also operate on the pixel signals and the FPN data without generating an image (or without generating an image that is appealing for a human observer). For example, the processing unit 1040 may execute classification tasks. It may classify the pixel signals according to the observed scenes (e.g. country sides, city) or may classify objects (e.g. persons, cars, roadsides) or movements (e.g. hand gestures, approaching objects) within the observed scenes. Further, the processing unit 1040 may also segment observed scenes (e.g. healthy tissue-pathological tissue, road-curb). In all these tasks the knowledge of the FPN of the pixel array 1010 that observed the scene helps to improve the quality of the accomplishment of the respective predetermined operation/task.

Further, instead of trying to generate fully FPN-compensated images on which the processing unit 1040 operates in order to fulfill its tasks, the step of generation of compensated images is skipped. In particular, the two-step approach of generating compensated images and using these images for the task does not use more information than the one-step approach of operating directly on the pixel signals and the FPN data. In both approaches the available information is on the one hand the pixel signals obtained from the observed scene and on the other hand the FPN of the particular pixel array 1010 that was used for capturing the scene. While the step of “correcting” the pixel signals might be necessary for a human operator to understand the effects of the FPN, it is in principle not necessary for successful processing of the data at hand. Moreover, in correcting FPN-effects information might even be lost. Thus, results that are based on corrected images may even be less reliable than results obtained from the combination of pixel signals and FPN data.

Thus, providing the pixel signals and the FPN data to the processing unit 1040 as input for the predetermined operation saves processing power (and thus energy) and may even improve the results.

The above advantages of direct processing of both FPN data and pixel signals are in particular present if the processing unit 1040 carries out the predetermined operation by using a first artificial intelligence algorithm 1045, preferably by using a first neural network. The first artificial intelligence algorithm 1045 can then be trained with data sets that correspond to an output of the used pixel array 1010 and the FPN data of this pixel array 1010. The first artificial intelligence algorithm 1045 does therefore only know the combination of FPN data and pixel signals output from the output unit 1030. Since it will be trained to obtain the best possible result for the respective task based on these data, also the result of the first artificial intelligence algorithm 1045 when using real data will be optimal.

Here, the processing unit 1040 (with or without the first artificial intelligence algorithm 1045) may be implemented on the same chip as the pixel array 1010, the storage unit 1020, and/or the output put 1030.

This allows providing chips that are designed to give as output already the result of the respectively predetermined operation, e.g. a fully compensated image captured by the pixel array 1010. The processing unit 1040 may also be designed as a general-purpose processor that can carry out different predetermined operations (with or without using an artificial intelligence algorithm). The processing unit 1040 may be located on a separate chip/die/substrate or even externally on a different device, like a different computer that can then be viewed as part of the sensor device 10. The processing unit 1040 may be configured to carry out different predetermined operations or tasks by using different artificial intelligence algorithms.

As mentioned above, the FPN data may not consist merely of the FPN values of the single pixels 51, i.e. of calibrated electrical signals obtained when imaging a predetermined calibration scene 1015, but may also be constituted by a compression of these calibrated electrical signals. This is exemplary shown on the right side of FIG. 17, where the FPN distribution A is transformed into a vector whose entries encode the essential properties of the FPN of the pixel array 1010. For example, a principle component analysis can be used to compress the FPN data.

Thus, the FPN data can be brought to a more compressed form that eases output of the data and reduces latency of the data output. The use of compressed data brings on the other hand no disadvantage, since the most relevant information is contained in the compressed FPN data and can be retrieved by decoding the FPN data. Moreover, when using the first artificial intelligence algorithm 1045, the FPN data can be used in their compressed form to train the first artificial intelligence algorithm 1045. Thus, the first artificial intelligence algorithm 1045 will know the FPN data only in their compressed form and will adjust itself such as to provide optimal results for this form of data.

Here, it is particularly advantageous if the compression is determined by a second artificial intelligence algorithm 1052, preferably a second neural network, that is trained together with the first artificial intelligence algorithm 1045. In such a configuration the training will not only decide on the performance of the first artificial intelligence algorithm 1045, but also on the performance of the second artificial intelligence algorithm 1052, i.e. on the particular compression. Thus, the task to be executed will influence the compression to be used, and the used compression will influence the particular implementation of the first artificial intelligence algorithm 1045. In this manner, it is possible to set up on optimal combination of data compression and operation on the available data that will in the end lead to an improved fulfillment of the respective task, such as high-quality image generation or more reliable classifications/segmentations.

The training of the first and second artificial intelligence algorithms 1045, 1052 can in principle be carried out in any manner that allows optimization of the compression and the achievement of the predetermined operation in a correlated manner. One particular, not limiting manner to train the first and second artificial intelligence algorithms 1045, 1052 will be explained in the following.

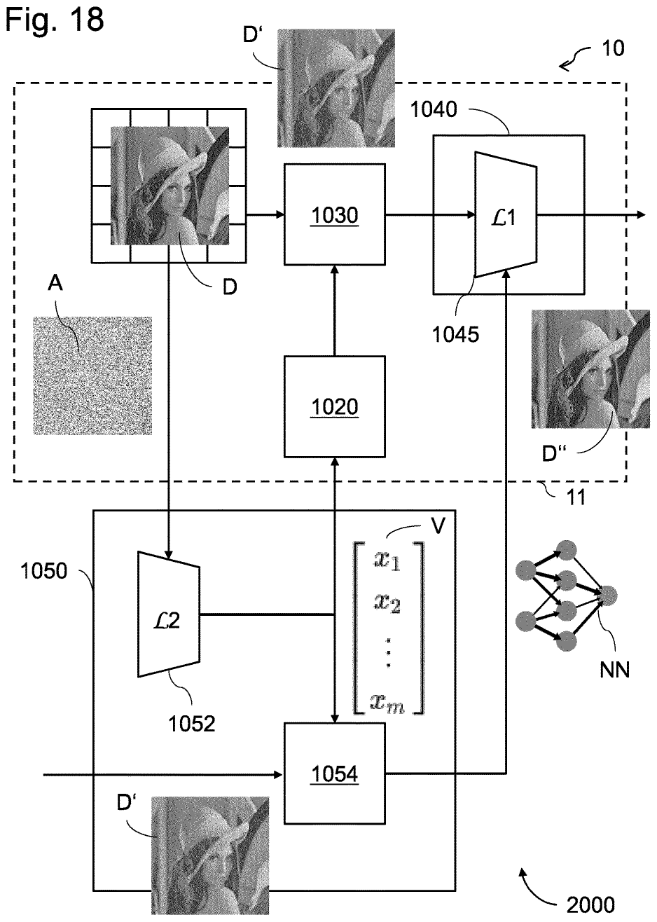

In particular, the training may be executed by a sensor system 2000 as schematically illustrated in FIG. 18. The sensor system 2000 comprises the sensor device 10 as described above and a simulation unit 1050. Here, the simulation unit 1050 may be any computer, processor, CPU, GPU, hardware, software, program and the like that can execute the functions described below. The simulation unit 1050 may be a separate unit on a separate chip or be even part of an external device like a server. However, the simulation unit 1050 may also be located on the sensor chip 11 or be part of the processing unit 1040. The term sensor system 2000 has therefore to be understood to include a sensor device 10 that can carry out all the functions described below as well as a sensor device 10 and external devices to which the sensor device 10 is coupled.

The simulation unit 1050 may be configured to simulate the generation of electrical signals by the pixels 51 of the pixel array 1010 during the training process. However, the training may in principle also be carried out based on real data acquisition. In this case, simulation by the simulation unit 1050 is not necessary.

The simulation unit 1050 is configured to train the first artificial intelligence algorithm 1045 and the second artificial intelligence algorithm 1052 together. To this end, a training data set is defined that is constituted by a plurality of scenes related to the predetermined operation to be carried out by the processing unit 1040. For example, if gesture recognition is the predetermined operation, the training data set will contain a plurality of videos of gestures as well as metadata indicating the class of gesture that can be seen on the video. If error free image generation is the task at hand, the training data will contain various error free images that are considered to represent the scene to be captured and which serve at the same time as feedback for the training process. In FIG. 18, the training data set is represented by error free image D.

The simulation unit further receives the calibrated electrical signals, i.e. the pixel signals obtained by viewing calibration scene 1015, i.e. a scene of uniform brightness and color. The calibrated electrical signals can e.g. be generated by imaging the calibration scene 1015 at the beginning of the training process, for example at the end of the manufacturing process of the sensor device 10. The calibration electrical signals may also be generated and stored in the storage unit 1020 or in a server during factory calibration and are provided only later to the simulation unit 1050, when the training is carried out. Moreover, capturing a calibration scene 1015 may also be possible, if the sensor device 10 is already in use. The training process could then also be executed for a sensor device 10 after calibration, e.g. during a camera update of a smartphone or after the purchase of a camera application or an image processing software supporting the features described herein.

Based on the training data set, the simulation unit 1050 will simulate the generation of electrical signals by the pixels 51 of the pixel array 1010 for each of the plurality of scenes. This means, the simulation of the simulation unit 1050 will generated electrical signals that include all (or the most important) errors of the pixel array 1010, and in particular the FPN. This is illustrated in FIG. 18 by the slightly noisy image D′. As stated above, if the training is carried out with actual image capturing, no simulation of pixel outputs will be necessary. In this case, it is only necessary to provide sufficient feedback data as training response, e.g. in training object classification by providing metadata indicating which object on a scene is which.

The simulation unit 1050 will then apply an initialized state of the second artificial intelligence algorithm 1052 to the calibrated electrical signals (represented by FPN distribution A in FIG. 18) to generate intermediate FPN data (represented by vector V in FIG. 18). Thus, the simulation unit 1050 starts with an initialized state of the second artificial intelligence algorithm 1052, e.g. by a particular setting of weights of a neural network, and carries out compression of the calibrated electrical signals in order to obtain intermediate FPN data, i.e. FPN data that are merely used during the next training steps but are not the optimized FPN data generated by the finally trained second artificial intelligence algorithm 1052.

Here, the second artificial intelligence algorithm 1052 has a loss function [symbol] that indicates how good the output of the second artificial intelligence algorithm 1052 is. The loss function [symbol] can be set by a human operator, e.g. based on a measure for the compression rate and the possibility to decompress and recover the compressed data. The loss function [symbol] may, however, only be implicitly set during the training of the combination of the first and second artificial intelligence algorithms by checking the estimate for the predetermined operation. In this sense, the loss function [symbol] is set by the first artificial intelligence algorithm implicitly based on a measure how well the compressed data can be used as input for the predetermined operation.

The intermediate FPN data (vector V in FIG. 18) as well as the simulated pixel signals (image D′ in FIG. 18) are stored in a memory 1054 of the simulation unit 1050. If the simulation unit 1050 is part of the sensor device 10 or the processing unit 1040, the memory 1054 may be part of the storage unit 1020.

On these intermediate FPN data and the simulated pixel signals an initialized state of the first artificial intelligence algorithm 1045 is applied. This means that with each of the scenes in the training data set the intermediate FPN data are combined. These combined data are used as input for an initialized state of the first artificial intelligence algorithm 1045, e.g. a neural network with a particular, initial setting of weights. Here, outcomes of the first artificial intelligence algorithm 1045 may be characterizable by a loss function [symbol] that indicates how good the predetermined operation has been executed. For example, for an image classification problem the loss function [symbol] may indicate whether an object was correctly classified, and if not, how far from correct the classification was. For image generation the loss function [symbol] may be the mean squared error between the image generated by the first artificial intelligence algorithm (represented by D″ in FIG. 18) and the corresponding original training image. In principle, various loss functions [symbol] are commonly known for different predetermined operations. All of these functions can be used as long as they allow to train the first artificial intelligence algorithm 1045 together with the second artificial intelligence algorithm 1052.

Then, the combined loss function [symbol] + [symbol] of the combination of the first artificial intelligence algorithm 1045 and the second artificial intelligence algorithm 1052 is minimized, where the loss function indicates the deviation from an expected outcome of the predetermined operation on the electrical signals simulated based on the training data set. In particular, various compressions of the FPN data are chosen that may or may not be based on the training results of the first artificial intelligence algorithm 1045. For each of these compressions, i.e. for each setup of the second artificial intelligence algorithm, the first artificial intelligence algorithm 1045 is trained.

Here, the optimization of the combined loss function may be carried out by using a gradient descent algorithm and/or by using backpropagation. For example, if both artificial intelligence algorithms 1045, 1052 are constituted by differentiable neural networks, the loss of the combined loss function (or the error of the combined system) might be backpropagated through the first neural network to the second neural network. The weights of both networks can then be determined based on a gradient descent algorithm. This means that the loss function [symbol] of the second neural network can be reduced via backpropagation without the need to explicitly define it. The output of the second neural network can be viewed as a further input layer of the first neural network in this setup. Thus, for the purpose of training both neural networks can be considered to form a single neural network.

After finishing the training, the simulation unit 1050 is configured to store the FPN data obtained from the optimized second artificial intelligence algorithm in the storage unit 1020 of the sensor device, and to store the optimized first artificial intelligence algorithm 1045 in the processing unit 1040 of the sensor device. For example, if a neural network NN is used as the first artificial intelligence algorithm 1045, the simulation unit 1050 stores the weights of the neural network in the processing unit 1045.

In this manner, it is possible to set up a sensor device 10 as described above that uses the first artificial intelligence algorithm 1045 to carry out the predetermined operation as well as compressed FPN data that are compressed based on a second artificial intelligence algorithm 1052 that has been trained together with the first artificial intelligence algorithm 1052.

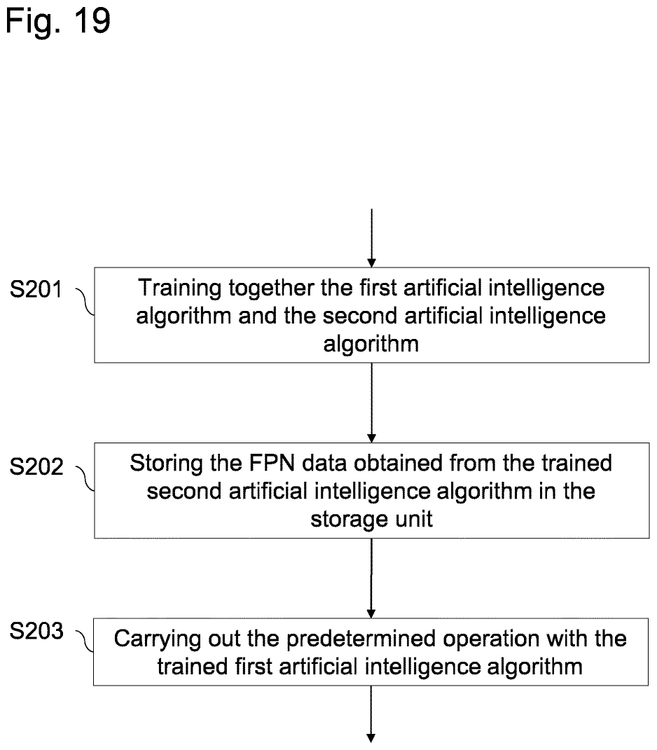

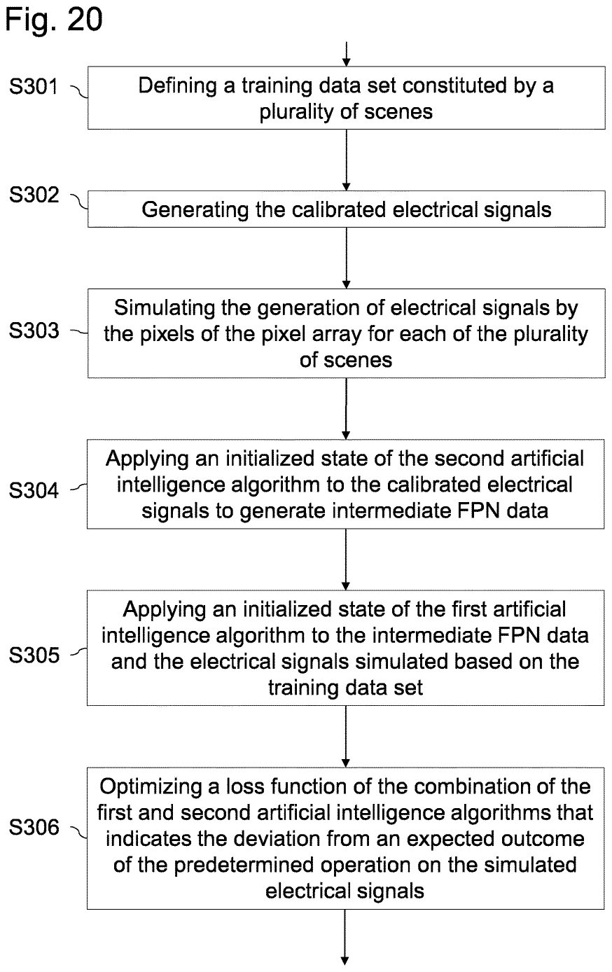

The above process can be summarized based on the process flows of FIGS. 19 and 20 that show methods for operating the sensor device 10/the sensor system 2000 such as to generate the FPN data used in the method for operating the sensor device discussed above with respect to FIG. 15.

In particular, as shown in FIG. 19, at S201 a first artificial intelligence algorithm 1045 and a second artificial intelligence algorithm 1052 are trained together, where the first artificial intelligence algorithm 1045 is configured to carry out a predetermined operation, preferably one of image generation, image classification, classification of movements, object classification, and image segmentation, based on the electrical signals and FPN data, and the second artificial intelligence algorithm 1052 is configured to determine a compression that is used to generate the FPN data from calibrated electrical signals of the pixels 51 obtained when imaging a predetermined calibration scene 1015.

At S202 the FPN data obtained from the trained second artificial intelligence algorithm 1052 are stored in the storage unit 1020 of the sensor device 1010, and at S203 the predetermined operation is carried out with the trained first artificial intelligence algorithm 1045.

Further, as shown in FIG. 20, S201, i.e. the training, may comprise at S301 defining a training data set constituted by a plurality of scenes, at S302 generating the calibrated electrical signals, and at S303 simulating the generation of electrical signals by the pixels 51 of the pixel array 1010 for each of the plurality of scenes.

At S304 an initialized state of the second artificial intelligence algorithm 1055 is applied to the calibrated electrical signals to generate intermediate FPN data, and at S305 an initialized state of the first artificial intelligence algorithm 1045 is applied to the intermediate FPN data and the electrical signals simulated based on the training data set.

Then, at S306 a loss function of the combination of the first artificial intelligence algorithm 1045 and the second artificial intelligence algorithm 1055 is minimized, where the loss function indicates the deviation from an expected outcome of the predetermined operation on the electrical signals simulated based on the training data set.

Of course, this manner of training the first and second artificial intelligence algorithms 1045, 1052 together is only exemplary, just as the usage of artificial intelligence algorithms at all. Of importance is merely that the FPN of the pixel array 1010 can be implicitly compensated by processing FPN data together with pixel signals instead of processing the pixel signals (or corrected versions thereof) alone. In this manner, various predetermined tasks can be carried out in a satisfactory manner without the need for a complex and expensive sensor setup.

The technology according to the above (i.e. the present technology) is applicable to various products. For example, the technology according to the present disclosure may be realized as a device that is installed on any kind of moving bodies, for example, vehicles, electric vehicles, hybrid electric vehicles, motorcycles, bicycles, personal mobilities, airplanes, drones, ships, and robots.

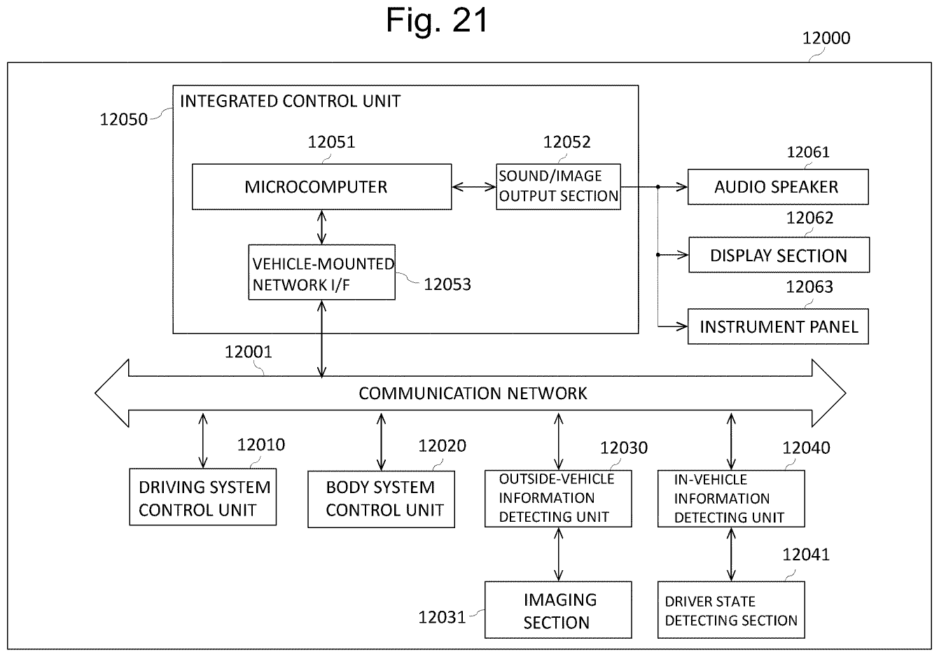

FIG. 21 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 21, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 21, an audio speaker 12061, a display section 12062, and an instrument panel 12063 are illustrated as the output device. The display section 12062 may, for example, include at least one of an on-board display and a head-up display.

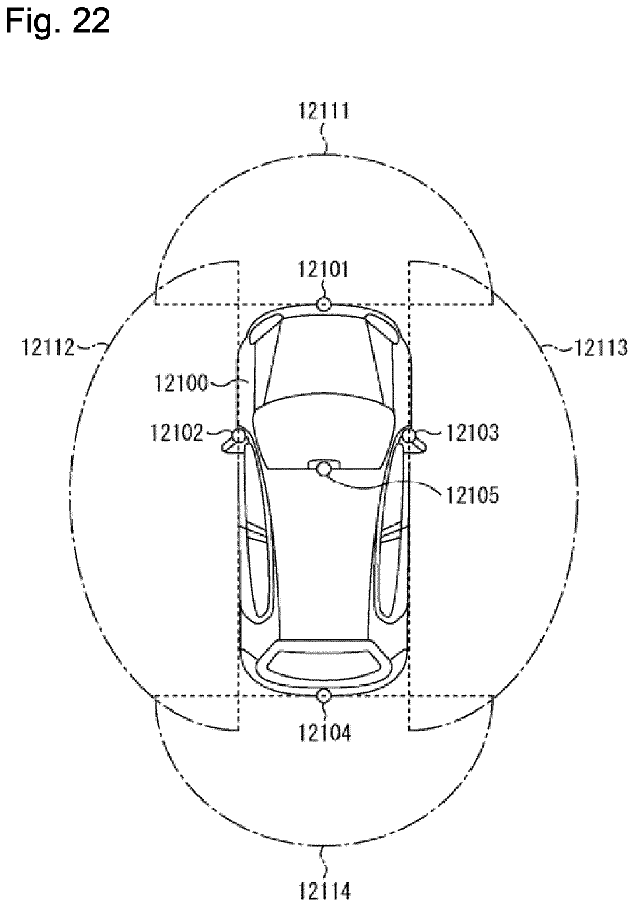

FIG. 22 is a diagram depicting an example of the installation position of the imaging section 12031.

In FIG. 22, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 22 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described above. The technology according to the present disclosure is applicable to the imaging section 12031 among the above-mentioned configurations. Specifically, the sensor device 10 is applicable to the imaging section 12031. The imaging section 12031 to which the technology according to the present disclosure has been applied flexibly acquires event data and performs data processing on the event data, thereby being capable of providing appropriate driving assistance.

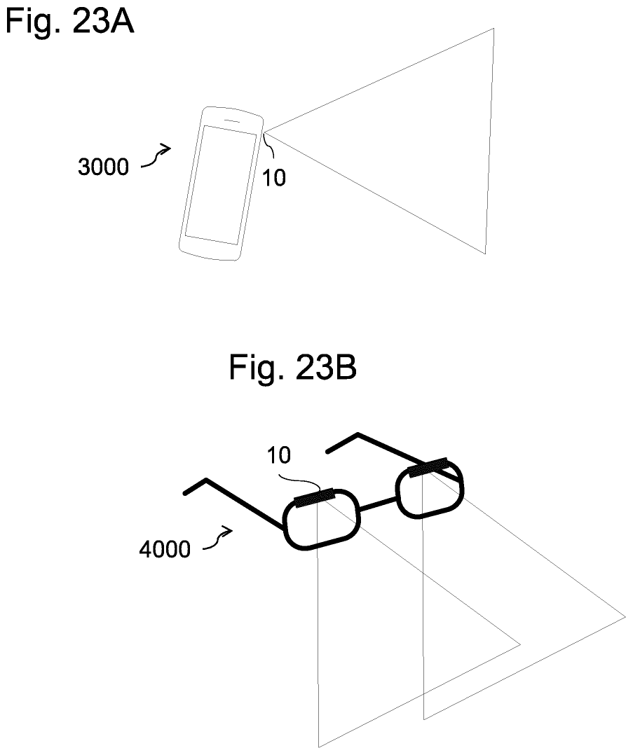

Further possible implementations of the sensor device 10 are mobile devices 3000 such as cell phones, tablets, smart watches and the like as shown in FIG. 23A or head-mounted displays 4000 as shown in FIG. 23B. Further, the sensor device 10 is useable in augmented and/or virtual reality applications/cameras or in surveillance systems like 360° cameras.

Note that, the embodiments of the present technology are not limited to the above-mentioned embodiment, and various modifications can be made without departing from the gist of the present technology.

Further, the effects described herein are only exemplary and not limited, and other effects may be provided.

Note that, the present technology can also take the following configurations.

[1] A sensor device (10) comprising:
a pixel array (1010) comprising a plurality of pixels (51) each being configured to receive light and to perform photoelectric conversion to generate an electrical signal;
a storage unit (1020) that is configured to store fixed pattern noise, FPN, data indicating FPN of the pixel array (1010); and
an output unit (1030) that is configured to output the electrical signals generated by the pixels (51) and the FPN data.

[2] The sensor device (10) according to [1], comprising
a single sensor chip (11) on which the pixel array (1010), the storage unit (1020), and the output unit (1030) are formed.

[3] The sensor device according (10) to any one of [1] or [2], wherein
the pixels (51) are event detection pixels that are each configured to generate event data based on the received light, which event data indicate as an event the occurrence of an intensity change of the light above an event detection threshold.

[4] The sensor device (10) according to any one of [1] to [3], further comprising
a processing unit (1040) that is configured to receive the electrical signals and the FPN data from the output unit (1030) and to carry out a predetermined operation, preferably one of image generation, image classification, classification of movements, object classification, and image segmentation, based on the electrical signals and the FPN data.

[5] The sensor device (10) according to [4], wherein
the processing unit (1040) carries out the predetermined operation by using a first artificial intelligence algorithm (1045), preferably by using a first neural network.

[6] The sensor device (10) according to any one of [1] to [5], wherein
the FPN data are constituted by calibrated electrical signals of the pixels obtained when imaging a predetermined calibration scene (1015).

[7] The sensor device (10) according to [5], wherein
the FPN data are constituted by a compression of calibrated electrical signals of the pixels obtained when imaging a predetermined calibration scene (1015); and
the compression is determined by a second artificial intelligence algorithm (1052), preferably a second neural network, that is trained together with the first artificial intelligence algorithm (1045).

[8] A sensor system (2000) comprising
the sensor device (10) according to [7]; and
a simulation unit (1050) that is configured to simulate the generation of electrical signals by the pixels (51) of the pixel array; wherein
the simulation unit (1050) is configured to train the first artificial intelligence algorithm (1045) and the second artificial intelligence algorithm (1052) by
   defining a training data set constituted by a plurality of scenes,
   receiving the calibrated electrical signals,
   simulating the generation of electrical signals by the pixels (51) of the pixel array for each of the plurality of scenes,
   applying an initialized state of the second artificial intelligence algorithm (1052) to the calibrated electrical signals to generate intermediate FPN data,
   applying an initialized state of the first artificial intelligence algorithm (1045) to the intermediate FPN data and the electrical signals simulated based on the training data set,
   minimize a loss function of the combination of the first artificial intelligence algorithm (1045) and the second artificial intelligence algorithm (1052), where the loss function indicates the deviation from an expected outcome of the predetermined operation on the electrical signals simulated based on the training data set; and
the simulation unit (1050) is configured to store the FPN data obtained from the optimized second artificial intelligence algorithm in the storage unit (1020), and to store the optimized first artificial intelligence algorithm in the processing unit.

[9] The sensor system (10) according to [8], wherein
the simulation unit is configured to minimize the loss function by a gradient descent algorithm.

[10] The sensor system (10) according to [9], wherein
the simulation unit is configured to minimize the loss function using backpropagation.

[11] A method for operating the sensor device (10) according to any one of [1] to [7] or for operating a sensor system (2000) according to any one of [8] to [10], the method comprising:
receiving light and performing photoelectric conversion to generate an electrical signal with pixels (51) of the pixel array (1010); and
outputting, with the output unit (1030), the electrical signals generated by the pixels (51) and the FPN data stored in the storage unit (1020).

[12] The method according to [11], further comprising
training together a first artificial intelligence algorithm (1045) that is configured to carry out a predetermined operation, preferably one of image generation, image classification, classification of movements, object classification, and image segmentation, based on the electrical signals and the FPN data, and a second artificial intelligence algorithm (1052) that is configured to determine a compression that is used to generate the FPN data from calibrated electrical signals of the pixels (51) obtained when imaging a predetermined calibration scene (1015);
storing the FPN data obtained from the trained second artificial intelligence algorithm (1052) in the storage unit (1020); and
carrying out the predetermined operation with the trained first artificial intelligence algorithm (1045).

[13] The method according to [12], wherein
the training comprises
   defining a training data set constituted by a plurality of scenes,
   generating the calibrated electrical signals,
   simulating the generation of electrical signals by the pixels (51) of the pixel array (1010) for each of the plurality of scenes,
   applying an initialized state of the second artificial intelligence algorithm (1052) to the calibrated electrical signals to generate intermediate FPN data,
   applying an initialized state of the first artificial intelligence algorithm (1045) to the intermediate FPN data and the electrical signals simulated based on the training data set, and
   optimizing a loss function of the combination of the first artificial intelligence algorithm (1045) and the second artificial intelligence algorithm (1052), where the loss function indicates the deviation from an expected outcome of the predetermined operation on the electrical signals simulated based on the training data set.

1. A sensor device comprising:
a pixel array comprising a plurality of pixels each being configured to receive light and to perform photoelectric conversion to generate an electrical signal;
a storage unit that is configured to store fixed pattern noise, FPN, data indicating FPN of the pixel array; and
an output unit that is configured to output the electrical signals generated by the pixels and the FPN data.

2. The sensor device according to claim 1, comprising
a single sensor chip on which the pixel array, the storage unit, and the output unit are formed.

3. The sensor device according to claim 1, wherein
the pixels are event detection pixels that are each configured to generate event data based on the received light, which event data indicate as an event the occurrence of an intensity change of the light above an event detection threshold.

4. The sensor device according to claim 1, further comprising
a processing unit that is configured to receive the electrical signals and the FPN data from the output unit and to carry out a predetermined operation, preferably one of image generation, image classification, classification of movements, object classification, and image segmentation, based on the electrical signals and the FPN data.

5. The sensor device according to claim 4, wherein
the processing unit carries out the predetermined operation by using a first artificial intelligence algorithm, preferably by using a first neural network.

6. The sensor device according to claim 1, wherein
the FPN data are constituted by calibrated electrical signals of the pixels obtained when imaging a predetermined calibration scene.

7. The sensor device according to claim 5, wherein
the FPN data are constituted by a compression of calibrated electrical signals of the pixels obtained when imaging a predetermined calibration scene; and
the compression is determined by a second artificial intelligence algorithm, preferably a second neural network, that is trained together with the first artificial intelligence algorithm.

8. A sensor system comprising
the sensor device according to claim 7; and
a simulation unit that is configured to simulate the generation of electrical signals by the pixels of the pixel array; wherein
the simulation unit is configured to train the first artificial intelligence algorithm and the second artificial intelligence algorithm by
defining a training data set constituted by a plurality of scenes,
receiving the calibrated electrical signals,
simulating the generation of electrical signals by the pixels of the pixel array for each of the plurality of scenes,
applying an initialized state of the second artificial intelligence algorithm to the calibrated electrical signals to generate intermediate FPN data,
applying an initialized state of the first artificial intelligence algorithm to the intermediate FPN data and the electrical signals simulated based on the training data set,
minimize a loss function of the combination of the first artificial intelligence algorithm and the second artificial intelligence algorithm, where the loss function indicates the deviation from an expected outcome of the predetermined operation on the electrical signals simulated based on the training data set; and
the simulation unit is configured to store the FPN data obtained from the optimized second artificial intelligence algorithm in the storage unit, and to store the optimized first artificial intelligence algorithm in the processing unit.

9. The sensor system according to claim 8, wherein
the simulation unit is configured to minimize the loss function by a gradient descent algorithm.

10. The sensor system according to claim 9, wherein
the simulation unit is configured to minimize the loss function using backpropagation.

11. A method for operating the sensor device according to claim 1, the method comprising:
receiving light and performing photoelectric conversion to generate an electrical signal with pixels of the pixel array; and
outputting, with the output unit, the electrical signals generated by the pixels and the FPN data stored in the storage unit.

12. The method according to claim 11, further comprising
training together a first artificial intelligence algorithm that is configured to carry out a predetermined operation, preferably one of image generation, image classification, classification of movements, object classification, and image segmentation, based on the electrical signals and the FPN data, and a second artificial intelligence algorithm that is configured to determine a compression that is used to generate the FPN data from calibrated electrical signals of the pixels obtained when imaging a predetermined calibration scene;
storing the FPN data obtained from the trained second artificial intelligence algorithm in the storage unit; and
carrying out the predetermined operation with the trained first artificial intelligence algorithm.

13. The method according to claim 12, wherein
the training comprises
defining a training data set constituted by a plurality of scenes,
generating the calibrated electrical signals,
simulating the generation of electrical signals by the pixels of the pixel array for each of the plurality of scenes,
applying an initialized state of the second artificial intelligence algorithm to the calibrated electrical signals to generate intermediate FPN data,
applying an initialized state of the first artificial intelligence algorithm to the intermediate FPN data and the electrical signals simulated based on the training data set, and
optimizing a loss function of the combination of the first artificial intelligence algorithm and the second artificial intelligence algorithm, where the loss function indicates the deviation from an expected outcome of the predetermined operation on the electrical signals simulated based on the training data set.
